(19) United States
(12) Patent Application Publication
(10) Pub. No.: US 2023/0341789 A1
(43) Pub. Date: Oct. 26, 2023

(54) TONER

(71) Applicant: CANON KABUSHIKI KAISHA, Tokyo (JP)

(72) Inventors: Yuzo Seino, Kanagawa (JP); TSUNEYOSHI TOMINAGA, Shizuoka (JP); KOKI INOUE, Shizuoka (JP); YUKI MASUDA, Shizuoka (JP)

(21) Appl. No.: 18/300,239

(22) Filed: Apr. 13, 2023

(30) Foreign Application Priority Data
Apr. 20, 2022 (JP) 2022-069392

(51) Int. Cl. G03G 9/087; C08F 220/46

(52) U.S. Cl. CPC G03G 9/08731; C08F 220/46; C08F 2800/20

(57) ABSTRACT

A toner having both of excellent low-temperature fixability and such high durable developability as to be free from causing any development stripe. The toner is a toner including a toner particle containing a crystalline resin as a binder resin. When a relative permittivity obtained at a time of impedance measurement of the toner under an environment at a temperature of 25° C. and a relative humidity of 50% is represented by εr, a difference Δεr between a relative permittivity εr(0.01 Hz) at a frequency of 0.01 Hz and a relative permittivity εr(383 kHz) at a frequency of 383 kHz satisfies a relationship of 0.21≤{εr(0.01 Hz)−εr(383 kHz)}≤0.48.

### BACKGROUND OF THE INVENTION

### Field of the Invention

The present disclosure relates to a toner for developing an electrostatic image (electrostatic latent image) to be used in image forming methods, such as electrophotography and electrostatic printing.

### Description of the Related Art

In recent years, a region in which electrophotography is utilized has been extending to commercial printing typified by package printing or advertisement printing, and hence it has been required to adapt to further improvements in speed and image quality as compared to those in the case of conventional use of the electrophotography in offices. In addition, there has been a growing demand for energy savings in copying machines or printers, and in particular, an attempt has been made to achieve the energy savings through a reduction in fixation temperature of a fixing unit.

To adapt to the improvement in speed and the energy savings, there has been known a technology including reducing the fixation temperature through use of a crystalline resin as the binder resin of a toner. Known examples of the crystalline resin include: a main-chain crystallizing resin that crystallizes in a main chain thereof as typified by crystalline polyester; and a side-chain crystallizing resin that crystallizes in a side chain thereof as typified by a long-chain alkyl acrylate polymer. Of those, a side-chain crystallizing resin has been known to show excellent low-temperature fixability because its degree of crystallinity is easily increased. Accordingly, the side-chain crystallizing resin has been widely investigated.

In Japanese Patent Application Laid-Open No. 2021-140015, there is a proposal of a toner using crystalline polyester, and both of excellent image formation, which can correspond to the environments under which the toner is used by various users and image modes to be used by the users, and low-temperature fixability have been achieved.

In Japanese Patent Application Laid-Open No. 2019-214706, there is a disclosure of a toner binder, which, while achieving both of low-temperature fixability and storage stability, satisfies hot offset resistance and charging stability through use of a vinyl resin using an acrylate and/or a vinyl ester as a monomer.

In Japanese Patent Application Laid-Open No. 2021-140015, however, the low-temperature fixability has not been satisfactory because the mass ratio of the crystalline polyester in the toner is low. In Japanese Patent Application Laid-Open No. 2019-214706, the low-temperature fixability is excellent because the mass ratios of the alkyl acrylate and the vinyl ester for forming the vinyl resin in a toner are high. However, there has been a disadvantage in that the electrostatic adhesion force of the toner becomes larger to cause a development stripe.

The use of a large amount of a crystalline resin excellent in sharp-melt property in a toner is effective in obtaining a satisfactory fixation temperature. However, an increase in mass ratio of the crystalline resin in the toner raises the conductivity of the toner to increase polarization charge derived from the conductivity. The polarization charge of the toner has an action of raising the adhesion force of the toner to a toner-regulating member in a developing unit. Accordingly, there has been a disadvantage in that the toner is liable to adhere to and deposit on the toner-regulating member at the time of its long-term use. In addition, when the toner adheres to and deposits on the toner-regulating member at the time of the long-term use, a development stripe is liable to occur, and hence there has occurred a disadvantage in that the durable developability of the toner reduces.

As described above, the toner increased in content of the crystalline resin is excellent in low-temperature fixability, but is liable to cause a disadvantage in terms of development stripe at the time of its long-term use, and hence it has been difficult to achieve both of low-temperature fixability and durable developability.

### SUMMARY OF THE INVENTION

In view of the foregoing, an aspect of the present disclosure is to provide a toner having both of excellent low-temperature fixability and excellent durable developability.

The inventors of the present disclosure have investigated the achievement of both of low-temperature fixability and durable developability. As a result, the inventors have found that the control of polarization charge derived from conductivity (movable charge) can control the electrostatic adhesion force of a toner to solve the above-mentioned disadvantages.

The present disclosure relates to a toner including a toner particle containing a crystalline resin as a binder resin, wherein when a relative permittivity obtained at a time of impedance measurement of the toner under an environment at a temperature of 25° C. and a relative humidity of 50% is represented by εr, a difference Δεr between a relative permittivity εr(0.01 Hz) at a frequency of 0.01 Hz and a relative permittivity εr(383 kHz) at a frequency of 383 kHz satisfies a relationship of 0.21≤{εr(0.01 Hz)-εr(383 kHz)}≤0.48.

Further features of the present disclosure will become apparent from the following description of exemplary embodiments with reference to the attached drawings.

### BRIEF DESCRIPTION OF THE DRAWINGS

FIG. 1 is a graph for showing an example of the dielectric relaxation characteristic of a toner to which the present disclosure is applicable.

FIG. 2 is a graph for showing an example of the electrical conduction characteristic of the toner to which the present disclosure is applicable.

### DESCRIPTION OF THE EMBODIMENTS

Embodiments are described in detail below. However, the invention is not limited to the following description. In the present disclosure, the description “XX or more and YY or less” or “XX to YY” representing a numerical range means a numerical range including a lower limit and an upper limit that are end points unless otherwise stated. In addition, when the numerical ranges are described in a stepwise manner, the upper and lower limits of each numerical range may be freely combined.

[Features of the Present Disclosure]

The present disclosure is a toner including a toner particle containing a crystalline resin as a binder resin, and is such a toner that the relaxation intensity of dielectric relaxation obtained at the time of its impedance measurement is controlled.

The crystalline resin refers to a resin showing a clear endothermic peak in measurement with a differential scanning calorimeter (DSC). The resin has a high degree of crystallinity and is excellent in sharp-melt property, and hence can improve the low-temperature fixability of the toner.

A relative permittivity at a high frequency is formed of orientation polarization derived from the electric dipole of the toner. Meanwhile, a relative permittivity at a low frequency is formed of the additional value of: polarization charge derived from the conductivity (movable charge) of the toner; and the orientation polarization that is a constant value. Accordingly, a relaxation intensity that is a difference between the value of the relative permittivity at low frequencies and the value thereof at high frequencies (hereinafter referred to as “polarization charge Δεr”) represents the polarization charge derived from the conductivity (movable charge).

The inventors of the present disclosure have found that when the polarization charge Δεr of a toner is controlled, the electrostatic adhesion force of the toner is controlled, and hence a toner achieving both of low-temperature fixability and developability can be provided. The inventors of the present disclosure have conceived the reason for the foregoing to be as described below.

The toner including the crystalline resin has a glass transition temperature Tg lower than that of an amorphous resin, and hence has a high orientation property. At this time, when movable charge is present in the toner, the movable charge is moved in a region in which the glass transition temperature Tg is low by thermal motion, contact charging (difference in work function at a heterojunction interface), and an electric field applied from the outside, and hence can be identified as conductivity that is an electrical characteristic. Accordingly, when the mass ratio of the crystalline resin in the toner is increased, the toner shows high conductivity. However, the conductivity does not show any ohmic characteristic, and falls within the category of a dielectric material (insulator).

The electrostatic adhesion force of the toner is mainly caused by dielectric polarization resulting from orientation polarization and polarization charge Δεr electrostatically induced by the conductivity (movable charge) of the toner. The toner including the crystalline resin shows a high orientation property, and hence has high orientation polarization. In addition, the toner shows high conductivity, and hence the polarization charge caused by the movable charge becomes higher. Because of those facts, the toner including the crystalline resin has a feature in that its electrostatic adhesion force is high.

A developing process in an electrophotographic printing process is performed by: a developing roller that rotates for conveying a toner to a photosensitive drum; and a toner-regulating member that forms a thin layer of the toner on the developing roller and controls the amount of the toner to be conveyed to the photosensitive drum. At this time, the toner including the crystalline resin has a high electrostatic adhesion force, and is hence liable to adhere to and deposit on the toner-regulating member at the time of its long-term use. When the toner adheres to and deposits on the toner-regulating member as described above, the conveyance of the toner to the photosensitive drum is inhibited, and hence a development failure such as a development stripe (vertical-line white stripe) is liable to occur.

Meanwhile, when the conductivity (movable charge) of the toner is controlled, the polarization charge Δεr thereof can be controlled, and hence the electrostatic adhesion force of the toner can be suppressed. Thus, both of low-temperature fixability and durable developability can be achieved.

In the present disclosure, it has been conceived that when an anion structure is fixed to an end portion of the crosslinked structure of the binder resin, or on the main chain thereof or on a side chain thereof, the conductivity of the toner concerning ionic conduction can be controlled by an attractive or repulsive force by an electrostatic interaction. Specifically, a sulfo group is fixed to the end portion of the crosslinked structure by a water-soluble polymerization initiator, such as potassium persulfate, sodium persulfate, or ammonium persulfate, or is fixed on the main chain or side chain by its hydrogen abstraction function.

When ionic conductivity in the toner is controlled as described above, the polarization charge Δεr derived from the conductivity (movable charge) of the toner can be controlled, and hence the electrostatic adhesion force of the toner can be controlled.

As described above, such a toner that the mass ratio of the crystalline resin in the toner is high and its conductivity is suppressed is obtained. Accordingly, a toner having both of excellent low-temperature fixability and excellent durable developability can be provided.

The toner according to the present disclosure is a toner including a toner particle containing a crystalline resin as a binder resin, in which when a relative permittivity obtained at the time of the impedance measurement of the toner under an environment at a temperature of 25° C. and a relative humidity of 50% is represented by εr, a difference (polarization charge Δεr) between a relative permittivity εr(0.01 Hz) at a frequency of 0.01 Hz and a relative permittivity εr(383 kHz) at a frequency of 383 kHz satisfies a relationship of 0.21≤{εr(0.01 Hz)-εr(383 kHz)}≤0.48.

The polarization charge Δεr preferably satisfies a relationship of 0.25≤{εr(0.01 Hz)-εr(383 kHz)}≤0.45.

Herein, the lower limit value of the polarization charge Δεr has a correlation with the mass ratio of the crystalline resin in the toner, and represents the desired upper limit of the fixation temperature of the toner. That is, a larger lower limit value of the polarization charge Δεr means that the toner is more excellent in low-temperature fixability. In contrast, the upper limit value of the polarization charge Δεr has a correlation with the electrostatic adhesion force of the toner, and represents the ease with which the toner adheres to and deposits on a developing blade. Accordingly, the upper limit value means the limit value of the durable developability of the toner.

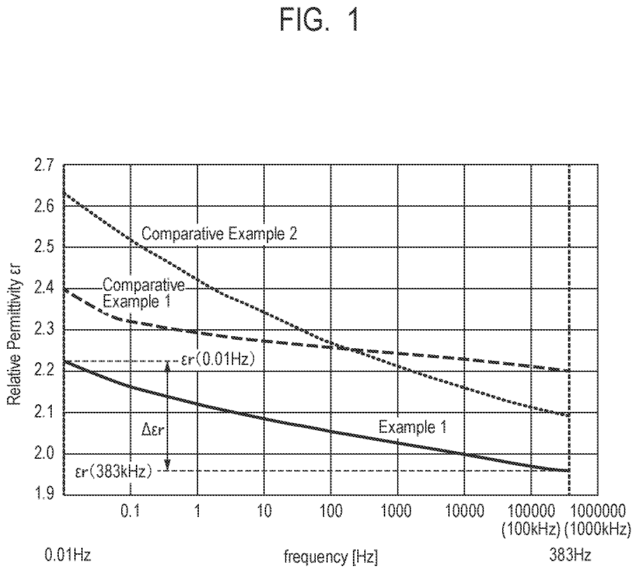

In addition, the polarization charge Δεr has a correlation with the conductivity of the toner, and the conductivity κ [S/m] of the toner at a frequency of 0.01 Hz, which is obtained at the time of the impedance measurement of the toner under the above-mentioned environment according to the present disclosure, is preferably 1.2×10⁻¹⁴ or more and 7.1×10⁻¹⁴ or less. The conductivity represents an electrical property satisfying the polarization charge Δεr. FIG. 1 is a graph for showing a relative permittivity with respect to a frequency (an example of the dielectric relaxation characteristic of the toner) based on a method of measuring the impedance of the toner to be described later, and data on Example 1, and Comparative Examples 1 and 2 to be described later is shown. In, for example, Example 1, the polarization charge Δεr is 0.26.

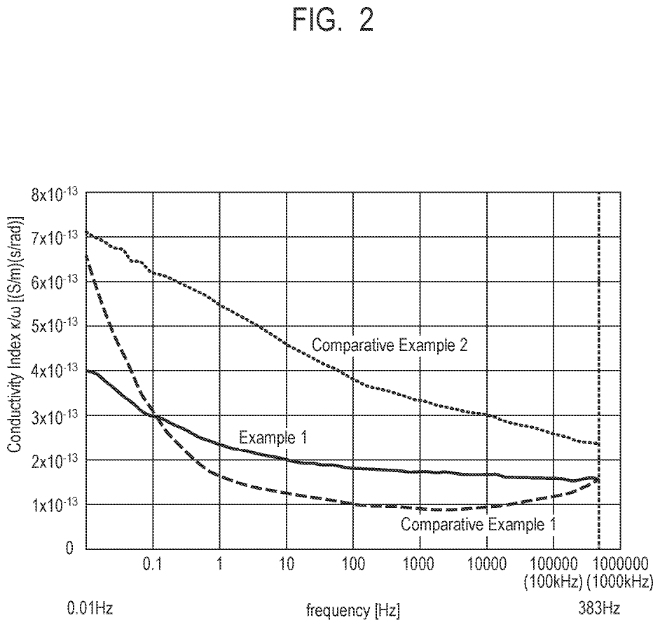

Similarly, the conductivity index κ/ω [(S/m)(s/rad)] of the toner at a frequency of 0.01 Hz, which is obtained at the time of the impedance measurement of the toner under the above-mentioned environment, is an index representing the conductivity of a dielectric material, and is preferably 1.9×10⁻¹³ or more and 11.4×10⁻¹³ or less. FIG. 2 is a graph for showing the conductivity index κ/ω with respect to a frequency (an example of the electrical conduction characteristic of the toner), and data on Example 1, and Comparative Examples 1 and 2 to be described later is shown. In, for example, Example 1, the conductivity index κ/ω (0.01 Hz) is 4.0×10⁻¹³.

Further, the minimum of the conductivity index κ/ω [(S/m)(s/rad)] in the sweep frequency range of from 0.01 Hz to 383 kHz, which is obtained at the time of the impedance measurement of the toner under the above-mentioned environment, depends on the content and electrical conductivity of a crystalline material, and is preferably 1.3×10⁻¹³ or more and 2.0×10⁻¹³ or less. In Example 1 in FIG. 2, the conductivity index κ/ω (minimum) is 1.6×10⁻¹³.

[Constituent Materials for Toner of the Present Disclosure]

Next, materials for forming the toner of the present disclosure are specifically described.

In the present disclosure, the term “(meth)acrylic acid ester” means an acrylic acid ester and/or a methacrylic acid ester.

The term “unit” refers to a reacted form of a monomer substance in a polymer. For example, one carbon-carbon bond block in a main chain obtained by the polymerization of a polymerizable monomer in the polymer is defined as one unit. The polymerizable monomer may be represented by the following formula (C):

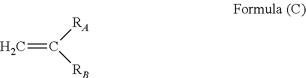

in the formula (C), RA represents a hydrogen atom or an alkyl group (preferably an alkyl group having 1 to 3 carbon atoms, more preferably a methyl group), and RB represents an optional substituent.

The crystalline resin refers to a resin showing a clear endothermic peak in measurement with a differential scanning calorimeter (DSC).

<Binder Resin>

The toner of the present disclosure preferably includes, as its binder resin, a unit (a) represented by the following formula (2) and/or a unit (b) represented by the following formula (3):

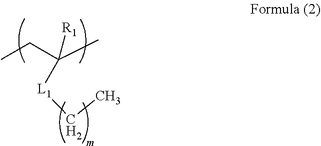

in the formula (2), R₁ represents a hydrogen atom or a methyl group, L₁ represents a single bond or a divalent linking group, and “m” represents an integer of 15 or more and 35 or less;

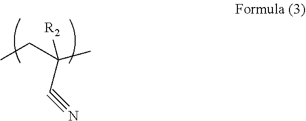

in the formula (3), R₂ represents a hydrogen atom or a methyl group.

When “m” of the formula (2) represents less than 15, the crystallinity of the binder resin tends to be insufficient. In addition, “m” preferably represents 17 or more and 29 or less from the viewpoint of the heat-resistant storage stability thereof.

A method of introducing the unit (a) into the binder resin is, for example, a method including subjecting a monomer, such as an α-olefin, a β-olefin, a (meth)acrylic acid ester, or an N-alkyl acrylamide having a long-chain alkyl group, to vinyl polymerization.

The unit (a) represented by the formula (2) in the binder resin is preferably a unit represented by the following formula (4) in terms of ease with which the physical properties of the binder resin, such as a SP value and a melting point, are controlled:

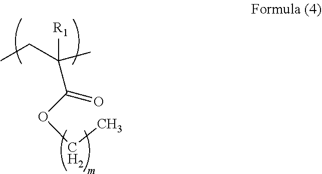

in the formula (4), R₁ represents a hydrogen atom or a methyl group, and “m” represents an integer of 15 or more and 35 or less.

A method of introducing the unit represented by the formula (4) is, for example, a method including subjecting each of such (meth)acrylic acid esters as listed below to vinyl polymerization.

Specific examples thereof include monomers, such as stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate, dotriacontyl (meth)acrylate, and 2-decyltetradecyl (meth)acrylate.

The monomers each having the unit (a) may be used alone or in combination thereof.

The ratio of the unit (a) in the binder resin is preferably 40.0% by mass or more and 80.0% by mass or less. When the ratio is set within the range, both the sharp-melt property and heat-resistant storage stability of the binder resin can be achieved. The ratio is more preferably 40.0% by mass or more and 70.0% by mass or less, still more preferably 40.0% by mass or more and 60.0% by mass or less.

Meanwhile, a method of introducing the unit (b) represented by the formula (3) into the binder resin is, for example, a method including subjecting acrylonitrile or methacrylonitrile to vinyl polymerization.

The ratio of the monomer unit (b) in the binder resin is preferably 5.0% by mass or more and 40.0% by mass or less, more preferably 20.0% by mass or more and 35.0% by mass or less.

The binder resin may have any other unit in addition to the unit (a) and the unit (b). A method of introducing the other unit is, for example, a method including polymerizing each of the monomers listed above and any other vinyl-based monomer.

Examples of the other vinyl-based monomer include the following monomers.

Styrene, α-methylstyrene, and (meth)acrylic acid esters, such as methyl (meth)acrylate, ethyl (meth)acrylate, n-butyl (meth)acrylate, t-butyl (meth)acrylate, and 2-ethylhexyl (meth)acrylate.

Monomers each having a urea group, such as a monomer obtained by causing an amine having 3 to 22 carbon atoms [e.g., primary amines (such as n-butylamine, t-butylamine, propylamine, and isopropylamine), secondary amines (such as di-n-ethylamine, di-n-propylamine, and di-n-butylamine), aniline, and cyclohexylamine] and an isocyanate having an ethylenically unsaturated bond and having 2 to 30 carbon atoms to react with each other by a known method.

Monomers each having a carboxy group, such as methacrylic acid, acrylic acid, and 2-carboxyethyl (meth)acrylate.

Monomers each having a hydroxy group, such as 2-hydroxyethyl (meth)acrylate and 2-hydroxypropyl (meth)acrylate.

Monomers each having an amide group, such as acrylamide, and a monomer obtained by causing an amine having 1 to 30 carbon atoms and a carboxylic acid having an ethylenically unsaturated bond and having 2 to 30 carbon atoms (e.g., acrylic acid and methacrylic acid) to react with each other by a known method.

Monomers each having a urethane group, such as a monomer obtained by causing an alcohol having an ethylenically unsaturated bond and having 2 to 22 carbon atoms (e.g., 2-hydroxyethyl methacrylate and vinyl alcohol) and an isocyanate having 1 to 30 carbon atoms [e.g., monoisocyanate compounds (such as benzenesulfonyl isocyanate, tosyl isocyanate, phenyl isocyanate, p-chlorophenyl isocyanate, butyl isocyanate, hexyl isocyanate, t-butyl isocyanate, cyclohexyl isocyanate, octyl isocyanate, 2-ethylhexyl isocyanate, dodecyl isocyanate, adamantyl isocyanate, 2,6-dimethylphenyl isocyanate, 3,5-dimethylphenyl isocyanate, and 2,6-dipropylphenyl isocyanate), aliphatic diisocyanate compounds (such as trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, and 2,4,4-trimethylhexamethylene diisocyanate), alicyclic diisocyanate compounds (such as 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, and hydrogenated tetramethylxylylene diisocyanate), and aromatic diisocyanate compounds (such as phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, and xylylene diisocyanate)] to react with each other by a known method, and a monomer obtained by causing an alcohol having 1 to 26 carbon atoms (e.g., methanol, ethanol, propanol, isopropyl alcohol, butanol, t-butyl alcohol, pentanol, heptanol, octanol, 2-ethylhexanol, nonanol, decanol, undecyl alcohol, lauryl alcohol, dodecyl alcohol, myristyl alcohol, pentadecyl alcohol, cetanol, heptadecanol, stearyl alcohol, isostearyl alcohol, elaidyl alcohol, oleyl alcohol, linoleyl alcohol, linolenyl alcohol, nonadecyl alcohol, heneicosanol, behenyl alcohol, and erucyl alcohol) and an isocyanate having an ethylenically unsaturated bond and having 2 to 30 carbon atoms [e.g., 2-isocyanatoethyl (meth)acrylate, 2-(0-[1′-methylpropylideneamino]carboxyamino)ethyl (meth)acrylate, 2-[(3,5-dimethylpyrazolyl)carbonylamino]ethyl (meth)acrylate, and 1,1-(bis(meth)acryloyloxymethyl)ethyl isocyanate] to react with each other by a known method.

Vinyl esters, such as vinyl acetate, vinyl propionate, vinyl butyrate, vinyl caproate, vinyl caprylate, vinyl caprate, vinyl laurate, vinyl myristate, vinyl palmitate, vinyl stearate, vinyl pivalate, and vinyl octoate.

Of those, styrene, methyl (meth)acrylate, or t-butyl (meth)acrylate is preferably used.

<Other Resin Component>

The toner of the present disclosure may include resin components in accordance with various purposes in addition to the binder resin. Examples of the usable resins include: a vinyl-based resin that does not correspond to the binder resin; polyester; polyurethane; and an epoxy resin.

Examples of a polymerizable monomer for forming the vinyl-based resin that does not correspond to the binder resin include the above-mentioned monomers except the monomers for forming the unit (a) or (b). Two or more kinds of such monomers may be used in combination as required.

The polyester may be obtained by a condensation polymerization reaction between a polyvalent carboxylic acid that is divalent or more and a polyhydric alcohol.

Examples of the polyvalent carboxylic acid include the following compounds.

Dibasic acids, such as succinic acid, adipic acid, sebacic acid, phthalic acid, isophthalic acid, terephthalic acid, malonic acid, and dodecenylsuccinic acid, and anhydrides or lower alkyl esters thereof, and aliphatic unsaturated dicarboxylic acids, such as maleic acid, fumaric acid, itaconic acid, and citraconic acid. 1,2,4-Benzenetricarboxylic acid, 1,2,5-benzenetricarboxylic acid, and anhydrides or lower alkyl esters thereof. Those compounds may be used alone or in combination thereof.

Examples of the polyhydric alcohol may include the following compounds.

Alkylene glycols (ethylene glycol, 1,2-propylene glycol, and 1,3-propylene glycol); alkylene ether glycols (polyethylene glycol and polypropylene glycol); an alicyclic diol (1,4-cyclohexanedimethanol); a bisphenol (bisphenol A); and alkylene oxide (ethylene oxide and propylene oxide) adducts of an alicyclic diol. An alkyl moiety of each of the alkylene glycol and the alkylene ether glycol may be linear or branched. In the present disclosure, the alkylene glycol having a branched structure may also be preferably used. Further examples include glycerin, trimethylolethane, trimethylolpropane, and pentaerythritol. Those compounds may be used alone or in combination thereof.

Monovalent acids, such as acetic acid and benzoic acid, and monohydric alcohols, such as cyclohexanol and benzyl alcohol, may also each be used as required for the purpose of adjusting an acid value or a hydroxyl value.

A method of producing the polyester is not particularly limited, but examples thereof include a transesterification method and a direct polycondensation method.

The polyurethane is obtained by a reaction between a diol component and a diisocyanate component.

Examples of the diisocyanate component include the following: an aromatic diisocyanate having 6 to 20 carbon atoms (excluding a carbon atom in an NCO group, and the same holds true for the following), an aliphatic diisocyanate having 2 to 18 carbon atoms, an alicyclic diisocyanate having 4 to 15 carbon atoms, and modified products of these diisocyanates (modified products each containing a urethane group, a carbodiimide group, an allophanate group, a urea group, a biuret group, a uretdione group, a uretonimine group, an isocyanurate group, or an oxazolidone group, which are hereinafter sometimes referred to as “modified diisocyanates”), and mixtures of two or more kinds thereof.

Examples of the aromatic diisocyanate include the following: m- and/or p-xylylene diisocyanate (XDI) and α,α,α′,α′-tetramethylxylylene diisocyanate.

In addition, examples of the aliphatic diisocyanate include the following: ethylene diisocyanate, tetramethylene diisocyanate, hexamethylene diisocyanate (HDI), and dodecamethylene diisocyanate.

In addition, examples of the alicyclic diisocyanate include the following: isophorone diisocyanate (IPDI), dicyclohexylmethane-4,4′-diisocyanate, cyclohexylene diisocyanate, and methylcyclohexylene diisocyanate.

Of those, an aromatic diisocyanate having 6 to 15 carbon atoms, an aliphatic diisocyanate having 4 to 12 carbon atoms, and an alicyclic diisocyanate having 4 to 15 carbon atoms are preferred, and XDI, IPDI, and HDI are particularly preferred.

In addition to the diisocyanate component, an isocyanate compound that is trifunctional or more may also be used.

The same alcohols as the above-mentioned dihydric alcohols that may be used in the polyester may each be adopted as the diol component that may be used in the polyurethane.

<Release Agent>

The toner may include a release agent. The release agent is preferably at least one selected from the group consisting of: a hydrocarbon-based wax; and an ester wax. The use of the hydrocarbon-based wax and/or the ester wax facilitates the securement of effective releasability. Although the hydrocarbon-based wax is not particularly limited, examples thereof include the following waxes: aliphatic hydrocarbon-based waxes: low-molecular weight polyethylene, low-molecular weight polypropylene, a low-molecular weight olefin copolymer, a Fischer-Tropsch wax, or waxes obtained by the oxidation or acid addition of these waxes.

The ester wax only needs to have at least one ester bond in a molecule thereof, and a natural ester wax and a synthetic ester wax may each be used. Although the ester wax is not particularly limited, examples thereof include the following waxes:
esters of a monohydric alcohol and a monocarboxylic acid, such as behenyl behenate, stearyl stearate, and palmityl palmitate;
esters of a divalent carboxylic acid and a monoalcohol, such as dibehenyl sebacate;
esters of a dihydric alcohol and a monocarboxylic acid, such as ethylene glycol distearate and hexanediol dibehenate;
esters of a trihydric alcohol and a monocarboxylic acid, such as glycerin tribehenate;
esters of a tetrahydric alcohol and a monocarboxylic acid, such as pentaerythritol tetrastearate and pentaerythritol tetrapalmitate;
esters of a hexahydric alcohol and a monocarboxylic acid, such as dipentaerythritol hexastearate, dipentaerythritol hexapalmitate, and dipentaerythritol hexabehenate;
esters of a polyfunctional alcohol and a monocarboxylic acid, such as polyglycerin behenate; and
natural ester waxes, such as carnauba wax and rice wax.

Of those, esters of a hexahydric alcohol and a monocarboxylic acid, such as dipentaerythritol hexastearate, dipentaerythritol hexapalmitate, and dipentaerythritol hexabehenate, are preferred.

The hydrocarbon-based wax or the ester wax may be used alone as the release agent, the hydrocarbon-based wax and the ester wax may be used in combination, or two or more kinds each of the hydrocarbon-based waxes and the ester waxes may be used as a mixture. However, it is preferred that the hydrocarbon-based waxes be used alone or in combination thereof. The release agent is more preferably the hydrocarbon-based wax.

The content of the release agent in each of the toner particles is preferably 1.0% by mass or more and 30.0% by mass or less, more preferably 2.0% by mass or more and 25.0% by mass or less. When the content of the release agent in each of the toner particles falls within the ranges, the releasability of the toner at the time of its fixation is easily secured.

The melting point of the release agent is preferably 60° C. or more and 120° C. or less. When the melting point of the release agent falls within the range, the release agent easily melts at the time of the fixation to exude to the surfaces of the toner particles, and hence its releasability is easily exhibited. The melting point is more preferably 70° C. or more and 100° C. or less.

<Colorant>

The toner may contain a colorant. Examples of the colorant include an organic pigment, an organic dye, an inorganic pigment, carbon black serving as a black colorant, and magnetic particles, which are known colorants. In addition to the foregoing, a colorant that has hitherto been used in a toner may be used.

Examples of a yellow colorant include the following: a condensed azo compound, an isoindolinone compound, an anthraquinone compound, an azo metal complex, a methine compound, and an arylamide compound. Specifically, C.I. Pigment Yellow 12, 13, 14, 15, 17, 62, 74, 83, 93, 94, 95, 109, 110, 111, 128, 129, 147, 155, 168, and 180 are suitably used.

Examples of a magenta colorant include the following: a condensed azo compound, a diketopyrrolopyrrole compound, an anthraquinone compound, a quinacridone compound, a base dye lake compound, a naphthol compound, a benzimidazolone compound, a thioindigo compound, and a perylene compound. Specifically, C.I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254 are suitably used.

Examples of the cyan colorant include the following: a copper phthalocyanine compound and derivatives thereof, an anthraquinone compound, and a base dye lake compound. Specifically, C.I. Pigment Blue 1, 7, 15, 15:1, 15:2, 15:3, 15:4, 60, 62, and 66 are suitably used. The colorant is selected from the viewpoints of a hue angle, chroma, lightness, light fastness, OHP transparency, and dispersibility in the toner.

The content of the colorant is preferably 1.0 part by mass or more and 20.0 parts by mass or less with respect to 100.0 parts by mass of the binder resin. When the magnetic particles are used as the colorant, the content is preferably 40.0 parts by mass or more and 150.0 parts by mass or less with respect to 100.0 parts by mass of the binder resin.

<Charge Control Agent>

A charge control agent may be incorporated into each of the toner particles as required. In addition, the charge control agent may be externally added to the toner particle. The blending of the charge control agent stabilizes the charge characteristic of the toner, and hence can control the triboelectric charge quantity thereof to an optimum value in accordance with a developing system. A known charge control agent may be utilized as the charge control agent, and a charge control agent having a high charging speed and capable of stably maintaining a constant charge quantity is particularly preferred.

Examples of the charge control agent that controls the toner so as to be negatively chargeable include the following compounds. An organometallic compound and a chelate compound are effective, and examples thereof include a monoazo metal compound, an acetylacetone metal compound, and aromatic oxycarboxylic acid-, aromatic dicarboxylic acid-, oxycarboxylic acid-, and dicarboxylic acid-based metal compounds.

Examples of the charge control agent that controls the toner so as to be positively chargeable include the following compounds: nigrosine, a quaternary ammonium salt, a metal salt of a higher fatty acid, diorganotin borates, a guanidine compound, and an imidazole compound. The content of the charge control agent is preferably 0.01 part by mass or more and 20.0 parts by mass or less, more preferably 0.5 part by mass or more and 10.0 parts by mass or less with respect to 100.0 parts by mass of the binder resin.

<External Additive>

The toner particles may be used as they are as the toner, or the toner may be obtained by mixing, for example, an external additive to cause the additive to adhere to each of the surfaces of the toner particles as required. Examples of the external additive include inorganic fine particles selected from the group consisting of: silica fine particles; alumina fine particles; and titania fine particles, or composite oxides thereof. Examples of the composite oxides include silica-aluminum fine particles and strontium titanate fine particles. The content of the external additive is preferably 0.01 part by mass or more and 8.0 parts by mass or less, more preferably 0.1 part by mass or more and 4.0 parts by mass or less with respect to 100 parts by mass of the toner particles.

[Method of Producing Toner]

Subsequently, a method of producing the toner is described. The toner particles may be produced by any one of conventionally known methods, such as a suspension polymerization method, an emulsion aggregation method, a dissolution suspension method, and a pulverization method, as long as the toner particles fall within the scope of the configuration of the present disclosure. A method of producing the toner based on the suspension polymerization method is described in detail below.

<Method of Producing Toner Based on Suspension Polymerization Method>

### (Dispersion Step)

Various materials, such as the polymerizable monomer for producing the binder resin and the colorant to be used as required, are mixed, and the materials are melted, dissolved, or dispersed with a dispersing machine to prepare a raw material dispersion liquid. Further, the wax and the charge control agent listed in the section “Constituent Materials for Toner of the Present Disclosure,” a solvent for viscosity adjustment, and any other additive may each be appropriately added to the raw material dispersion liquid as required. A known solvent may be used as the solvent for viscosity adjustment without any particular limitation as long as the materials can be satisfactorily dissolved and dispersed in the solvent, and the solvent has low solubility in water. Examples thereof include toluene, xylene, and ethyl acetate. In addition, examples of the dispersing machine include a homogenizer, a ball mill, a colloid mill, and an ultrasonic dispersing machine.

(Granulation Step)

The raw material dispersion liquid is loaded into an aqueous medium prepared in advance, and is dispersed therein with a dispersing machine, such as a high-speed stirring machine or an ultrasonic dispersing machine, to prepare a suspension. A dispersion stabilizer for adjusting the particle diameters and suppressing the aggregation is preferably incorporated into the aqueous medium. A conventionally known dispersion stabilizer may be used as the dispersion stabilizer without any particular limitation.

For example, as an inorganic dispersion stabilizer, there are given: phosphoric acid salts as typified by hydroxyapatite, tribasic calcium phosphate, dibasic calcium phosphate, magnesium phosphate, aluminum phosphate, zinc phosphate, and the like; carbonic acid salts as typified by calcium carbonate, magnesium carbonate, and the like; metal hydroxides as typified by calcium hydroxide, magnesium hydroxide, aluminum hydroxide, and the like; sulfuric acid salts as typified by calcium sulfate, barium sulfate, and the like; and calcium metasilicate, bentonite, silica, and alumina.

In addition, as an organic dispersion stabilizer, there are given polyvinyl alcohol, gelatin, methylcellulose, methylhydroxypropylcellulose, ethylcellulose, a sodium salt of carboxymethylcellulose, polyacrylic acid and salts thereof, and starch.

Of those, an inorganic dispersion stabilizer is preferred because of the following reason: the stabilizer shows a strong adsorption force to an oil phase by virtue of large polarization of its charge, and hence its aggregation-suppressing effect is strong. In addition, hydroxyapatite, tribasic calcium phosphate, and dibasic calcium phosphate are more preferred because the materials can each be easily removed through pH adjustment.

(Polymerization Step)

The polymerizable monomer in the suspension is polymerized to provide the toner particles. A polymerization initiator may be mixed together with the other additive at the time of the preparation of the raw material dispersion liquid, or may be mixed into the raw material dispersion liquid immediately before the suspension of the liquid in the aqueous medium. In addition, the initiator in the state of being dissolved in the polymerizable monomer or any other solvent may be added as required during the granulation step or after the completion of the granulation step, that is, immediately before the initiation of the polymerization step or during the polymerization step. After the polymerizable monomer has been polymerized to provide a polymer, desolvation treatment is performed by heating the resultant mixture or reducing a pressure therein as required. Thus, an aqueous dispersion liquid of the toner particles is obtained.

A known polymerization initiator may be used as the polymerization initiator without any particular limitation. Specific examples thereof include the following initiators.

As an oil-soluble initiator, there are given: pigment dispersants, such as 2,2′-azobisisobutyronitrile, 2,2′-azobis-2,4-dimethylvaleronitrile, 1,1′-azobis(cyclohexane-1-carbonitrile), and 2,2′-azobis-4-methoxy-2,4-dimethylvaleronitrile; and peroxide-based initiators, such as acetylcyclohexylsulfonyl peroxide, diisopropyl peroxycarbonate, decanonyl peroxide, lauroyl peroxide, stearoyl peroxide, propionyl peroxide, acetyl peroxide, t-butyl peroxy-2-ethylhexanoate, benzoyl peroxide, t-butyl peroxyisobutyrate, cyclohexanone peroxide, methyl ethyl ketone peroxide, dicumyl peroxide, t-butyl hydroperoxide, di-t-butyl peroxide, t-butyl peroxypivalate, and cumene hydroperoxide. The oil-soluble initiators may be used in combination thereof.

As a water-soluble initiator, there are given ammonium persulfate, potassium persulfate, 2,2′-azobis(N,N′-dimethyleneisobutyroamidine) hydrochloride, 2,2′-azobis(2-amidinopropane) hydrochloride, azobis(isobutylamidine) hydrochloride, sodium 2,2′-azobisisobutyronitrile sulfonate, ferrous sulfate, and hydrogen peroxide. In particular, in order that the amount of a sulfo group permeating from the surface layer of the toner may be adjusted with the water-soluble initiator, ammonium persulfate, sodium persulfate, potassium persulfate, or the like is preferably used.

In the present disclosure, a sulfo group of the water-soluble initiator is fixed to an end portion of the crosslinked structure of the binder resin, or on the main chain thereof or on a side chain thereof, and hence an electrostatic interaction is applied to a movable ion present in the toner. Thus, the ionic conductivity of the toner can be controlled. As a result of the foregoing, polarization charge Δεr derived from the conductivity of the toner can be controlled, and hence the electrostatic adhesion force of the toner can be controlled. At this time, the amount of the sulfo group present on the surface layer of the toner may be measured by time-of-flight secondary ion mass spectrometry TOF-SIMS to be described later, and an ion count Ic1 is preferably 0.005 or more and 0.05 or less. The lower limit value of the ion count Ic1 represents the boundary value at which the polarization charge Δεr derived from the conductivity is suppressed. In addition, the upper limit value of the ion count Ic1 represents the value at which the low-temperature fixability of the toner can be satisfied because the crosslinked structure fluctuates depending on the formulation of the binder resin.

The concentration of the above-mentioned polymerization initiator preferably falls within the range of from 0.1 part by mass to 20 parts by mass with respect to 100 parts by mass of the polymerizable monomer, and the concentration more preferably falls within the range of from 0.1 part by mass to 10 parts by mass with respect thereto. Although the kind of the polymerization initiator slightly varies depending on a polymerization method, the initiators are used alone or as a mixture thereof in consideration of their 10-hour half-life temperatures.

In the present disclosure, when the water-soluble polymerization initiator and the oil-soluble polymerization initiator are used in combination, and the anion structures of the polymerization initiators are each fixed to an end portion of the crosslinked structure of the binder resin, or on the main chain thereof or on a side chain thereof, the ionic conductivity of the toner can be controlled.

In the polymerization step, a first polymerizable monomer represented by the following formula (A) forms the monomer unit (a) represented by the formula (2), and a second polymerizable monomer represented by the following formula (B) forms the monomer unit (b) represented by the formula (3):

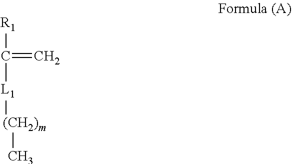

in the formula (A), R₁ represents a hydrogen atom or a methyl group, L₁ represents a single bond or a divalent linking group, and “m” represents an integer of 15 or more and 35 or less;

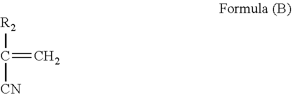

in the formula (B), R₂ represents a hydrogen atom or a methyl group.

In addition, in the polymerization step, separately from the oil-soluble polymerization initiator, the water-soluble polymerization initiator is preferably added when the polymerization conversion ratio of the first polymerizable monomer represented by the formula (A) is 30.0% or more, and the polymerization conversion ratio of the second polymerizable monomer represented by the formula (B) is 90.0% or less. When the water-soluble polymerization initiator is added at the timing within the range, the anion structure of the water-soluble polymerization initiator can be fixed to an end portion of a crosslinked structure in the surface layer portion of the toner, or on the main chain thereof or on a side chain thereof. As a result, the electrostatic adhesion force of the toner can be controlled by polarization charge Δεr derived from the conductivity of the toner, and hence the toner can be suppressed from adhering to and depositing on the toner-regulating member.

(Filtration Step, Washing Step, Drying Step, Classification Step, and External Addition Step)

A filtration step of obtaining a solid content from the aqueous dispersion liquid of the toner particles through solid-liquid separation, and as required, a washing step, a drying step, and a classification step for the adjustment of the particle sizes are performed to provide the toner particles. The toner particles may be used as they are as the toner. The toner may be obtained by mixing the toner particles and an external additive such as inorganic fine powder with a mixing machine to cause the additive to adhere to the particles as required.

[Methods of measuring Physical Properties according to Toner of the Present Disclosure]

Various measurement methods are described below.

<Method of measuring Impedance of Toner>

An electrical AC characteristic of the toner (powder) may be obtained by measuring its impedance through use of a parallel-plate capacitor method.

A jig for powder measurement including a four-terminal sample holder SH2-Z (manufactured by TOYO Corporation) and a torque wrench adapter SH-TRQ-AD (option), and a material test system ModuLab XM MTS (manufactured by Solartron Analytical Corporation) are used as devices. In addition, a noise cut transformer NCT-I3 1.4 kVA (manufactured by DENKENSEIKI Research Institute Co., Ltd.) for suppressing commercial power source noise and a shield box for suppressing electromagnetic wave noise are used.

The jig for powder measurement is configured to be capable of measuring a resistance of from 0.1 S2 to 1 TΩ with respect to an electric signal having a maximum peak-to-peak voltage of 500 V and a frequency of from DC to 1 MHz through use of: the four-terminal sample holder and the torque wrench adapter SH-TRQ-AD that is an option; and an upper electrode (solid electrode having a diameter of 25 mm) SH-H25AU and a lower electrode for a liquid and powder (including a central electrode having a diameter of 10 mm and a guard electrode having a diameter of 26 mm) SH-2610AU serving as parallel-plate electrodes. In addition, the torque wrench adapter SH-TRQ-AD (manufactured by TOYO Corporation) is mounted on a micrometer to be used in the measurement of a thickness between the upper and lower electrodes, the micrometer being included in the four-terminal sample holder, for adjusting the pressure of a powder sample. A torque driver RTD15CN (manufactured by Tohnichi Manufacturing Co., Ltd.) and a 6.35-millimeter square bit are used as a torque driver to be used in pressurization management, and the driver is configured to be capable of performing such management that clamping torque for toner measurement becomes 6.5 cN·m.

In the electrical AC characteristic measurement, the impedance of the toner is measured with the material test system ModuLab XM MTS (manufactured by Solartron Analytical Corporation). The ModuLab XM MTS includes a control module XM MAT 1 MHz, a high-voltage module XM MHV100, a femto-current module XM MFA, and a frequency response analysis module XM MRA 1 MHz, and XM-studio MTS Ver. 3.4 manufactured by the company is used as its control software.

The electrical AC characteristic of the powder that is a dielectric material (insulator) such as a toner is measured under the following conditions: the mode of the system is set to a normal mode in which only the measurement is performed; a DC bias is set to 0 V; and a sweep frequency is changed from 1 MHz to 0.01 Hz (12 points/decade).

Further, in view of noise suppression and the shortening of a measurement time, the following settings are added for the respective sweep frequencies.
A sweep frequency of from 1 MHz to 100 Hz, an AC level of 1 Vrms, and a measurement integration time of 1 second; 768 cycles
A sweep frequency of from 100 Hz to 10 Hz, an AC level of 7 Vrms, and a measurement integration time of 1 second; 96 cycles
A sweep frequency of from 10 Hz to 1 Hz, an AC level of 7 Vrms, and a measurement integration time of 1 second; 32 cycles
A sweep frequency of from 1 Hz to 0.1 Hz, an AC level of 7 Vrms, and a measurement integration time of 10 seconds; 4 cycles
A sweep frequency of from 0.1 Hz to 0.01 Hz, an AC level of 7 Vrms, and a measurement integration time of 10 seconds; 1 cycle

The impedance characteristic of the toner that is an electrical AC characteristic is measured under the above-mentioned measurement conditions.

When the measurement is performed under the above-mentioned conditions with the jig for powder measurement based on the parallel-plate capacitor method, the impedance characteristics of air and the sample in a thickness “d” in accordance with the size S of the measuring electrode having a diameter of 10 mm and the pressurization torque are obtained.

An electrostatic capacity C and a conductance (conductivity) G that are highly reliable are obtained from the resultant impedance characteristics of the air and the sample by performing the data correction treatment of a measurement system. The relative permittivity and conductivity of the toner that are electrical properties are determined from the electrostatic capacity C and the conductance (conductivity) G thus obtained, and the geometric shape (the size S of each of the parallel-plate electrodes and the thickness of the sample) of the jig for powder measurement.

When the four-terminal sample holder SH2-Z is used for the first time, the four-terminal sample holder SH2-Z to be used in the jig for powder measurement has an individual difference, and hence the following two verifications need to be performed for finding optimum measurement conditions. The first verification is the thickness dependence characteristic of the four-terminal sample holder. The thickness (distance between the upper and lower electrodes) dependence of the air is measured, and an error between the theoretical value and measured value of the electrostatic capacity is identified, followed by the grasping of an optimum thickness range in which the measurement error becomes minimum or a thickness at which the optimum measurement value can be obtained. The second verification is the measurement of a mechanical error. In the measurement of the powder sample, a load whose torque has been managed is applied for keeping the volume density of the sample constant. In contrast, the air is measured under an unloaded state. At this time, a thickness error is caused by the influences of the dimensions such as mechanical processing accuracy. Accordingly, offset values of the loaded state and the unloaded state of the managed value of the clamping torque (6.5 cN·m in the jig) are identified, and an offset correction value is determined.

Specific procedures for the production and measurement of the sample are as described below.
(1) The powder sample is placed on the central electrode portion of the lower electrode, and is molded into a trapezoidal shape having a height of 5 mm.
(2) The lower electrode having placed thereon the powder sample is mounted on the four-terminal sample holder SH2-Z, and the upper electrode is lowered.
(3) At this time, the upper electrode is lowered up to the upper end portion of the powder sample while its lowering speed is kept constant so that the electrode may not accidentally rotate.
(4) While the upper electrode is rotated left and right, smoothing treatment is performed so that the powder sample may be smooth.
(5) While the thickness is adjusted to a predetermined value with the micrometer, the rotation direction of the upper electrode is kept uniform so as to be a CW direction.
(6) In the case of the toner, the toner is pressurized with the torque driver managed to have a clamping torque of 6.5 cN·m.
(7) The thickness “d” of the powder sample is measured with the micrometer.
(8) The impedance measurement of the sample is performed under the above-mentioned conditions.
(9) After the completion of the measurement, the upper electrode is elevated, and the lower electrode is removed. At this time, the lower electrode is removed while sufficient attention is paid so that the powder sample may not enter the contact terminal for a lower electrode of the four-terminal sample holder, followed by the protection with a masking tape.
(10) The upper and lower electrodes are washed.
(11) The masking tape is removed, and the lower electrode is mounted.
(12) The thickness is adjusted to the thickness “t” of the air obtained by factoring the offset correction value in the unloaded state into the sample thickness “d” determined in the step (7), and the rotation direction of the upper electrode is kept uniform so as to be a constant direction.
(13) The impedance measurement of the air is performed.
(14) When the measured data (dielectric loss tangent; tan δ) of the air measured in the step (13) becomes larger than 0.001 in the frequency region of from 100 Hz to 0.021 Hz, the washing is insufficient. Accordingly, the operation is newly performed again from the step (10), that is, the washing step.

The measurement is performed at 25° C.

A specific data processing procedure is as described below.
(15) The error of a phase characteristic with respect to a theoretical value is calculated from the measured impedance characteristic of the air to provide the phase correction data of the material test system ModuLab XM MTS (manufactured by Solartron Analytical Corporation).
(16) The phase correction data calculated in the step (15) is applied to the impedance characteristic of the air measured in the step (13) to provide the impedance characteristic of the air subjected to phase correction treatment.
(17) The electrostatic capacity Ca of the air is calculated from the admittance Ya=Ga+jωCa of the impedance characteristic of the air subjected to phase correction, and an error between the calculated value and theoretical value is calculated to provide correction data a on a thickness error.
(18) The phase correction data obtained in the step (15) is applied to the impedance characteristic of the powder sample measured in the step (8).
(19) The relative permittivity and conductivity of the powder sample that are highly reliable are obtained by calculation through use of the electrostatic capacity Ca of the air and its correction data a determined in the step (17), and the complex admittance Ym=Gm+jωCm of the characteristic subjected to the phase correction treatment of the step (18).

<Analysis of Monomers of Resin Components Such as Binder Resin>

The kinds of the monomers of the resin components such as the binder resin are identified by analyzing the sample of each resin component fractionated from the toner under the following conditions with a pyrolysis GC/MS apparatus.
Measuring apparatus: “Voyager” (product name, manufactured by Thermo
Electron Corporation)
Pyrolysis temperature: 600° C.
Column: HP-1 (15 m×0.25 mm×0.25 μm)
Inlet: 300° C.
Split: 20.0
Injection amount: 1.2 mL/min
Temperature increase: 50° C. (4 min) to 300° C. (20° C./min)

<Measurement of Secondary Ion on Surfaces of Toner Particles Through Use of Time-of-Flight Secondary Ion Mass Spectrometry TOF-SIMS>

The depth profile of an ion derived from the resin for forming the surfaces of the toner particles was measured with a TOF-SIMS (TRIFTIV) manufactured by ULVAC-PHI, Inc. Conditions are as described below.

[Sample Adjustment]

An indium plate is mounted on a sample holder, and the toner particles are caused to adhere thereonto. If the toner particles move on the sample holder, the toner particles may be fixed with a carbon paste applied onto the indium plate mounted on the sample holder. When a fixing aid such as the carbon paste or a silicon wafer is used, a background is subjected to the measurement under a state in which the toner particles are absent and under the same conditions, and the measured value is converted.

[Sputtering Conditions]
Sputter ion species: An argon cluster ion ((Arn)⁺, “n” represents about 2,000)
Acceleration voltage: 10 keV
Current value: 8.5 nA
Sputtering area: 600×600 μm²
Sputtering time: 2 sec/cycle
Sputtering rate: 1 nm/sec

With regard to the above-mentioned sputtering rate, a polymethyl methacrylate resin having a thickness of 300 nm was sputtered under the above-mentioned sputtering conditions, and a time period required for the completion of the sputtering of the resin having a thickness of 300 nm was calculated, followed by the conversion of the calculated value into the rate through normalization.

[Analysis Conditions]
Primary ion species: A gold ion (Au⁺)
Acceleration voltage: 30 keV
Current value: 2 pA
Analysis area: 300×300 μm²
Number of pixels: 64×64 pixels
Analysis time: 4 sec/cycle
Repetition frequency: 8.2 kHz
Charging neutralization: ON
Secondary ion polarity: Positive
Range of mass-to-charge ratio (m/z) of secondary ion: From 0.5 to 1,850

[Calculation of Ic1]

After the monomer kind of the binder resin has been identified by the above-mentioned monomer analysis, the intensity ratio of the ion count of a secondary ion derived from a sulfo group, the ion having a mass-to-charge ratio of 80, to the count (total ion count) of ions derived from all resins including the binder resin on the outermost surfaces of the toner particles in the secondary ion mass-to-charge ratio range of from 0.5 to 1,850 is adopted as the Ic1.

(Separation of Toner Particles from Toner)

The above-mentioned measurement may be performed by using the toner particles separated from the toner as described below.

To 100 mL of ion-exchanged water, 160 g of sucrose (manufactured by Kishida Chemical Co., Ltd.) is added, and is dissolved therein while being heated in a water bath. Thus, a sucrose thick liquid is prepared. Into a tube for centrifugal separation (volume: 50 ml), 31 g of the sucrose thick liquid and 6 mL of CONTAMINON N (10% by mass aqueous solution of a neutral detergent for washing a precision measuring device, the solution being formed of a nonionic surfactant, an anionic surfactant, and an organic builder, and having a pH of 7, manufactured by Wako Pure Chemical Industries, Ltd.) are loaded. To the tube, 1.0 g of the toner is added, and the block of the toner is loosened with a spatula or the like. The tube for centrifugal separation is shaken with a shaker (AS-1N sold by AS ONE Corporation) at 300 spm (strokes per minute) for 20 minutes. After the shaking, the solution is transferred to a glass tube (50 mL) for a swing rotor, and is separated with a centrifugal separator (H-9R manufactured by KOKUSAN Co., Ltd.) under the conditions of 3,500 rpm and 30 minutes.

The toner particles and their external additive are separated from each other by the operation. It is visually observed that the toner particles and the aqueous solution are sufficiently separated from each other, followed by the collection of the toner particles separated into the uppermost layer with a spatula or the like. The collected toner particles are filtered with a vacuum filter, and are then dried with a dryer for 1 hour or more to provide a sample for measurement. The operation is performed a plurality of times to secure a required amount.

<Method of measuring Ratio of Various Monomer Units Contained in Binder Resin>

The ratio of various monomer units contained in the binder resin are measured by ¹H-NMR under the following conditions.
Measuring apparatus: A FT NMR apparatus JNM-EX400 (manufactured by JEOL Ltd.)
Measurement frequency: 400 MHz
Pulse condition: 5.0 μs
Frequency range: 10,500 Hz
Number of scans: 64 times
Measurement temperature: 30° C.
Sample: 50 mg of a measurement sample is loaded into a sample tube having an inner diameter of 5 mm, and deuterated chloroform (CDCl₃) is added as a solvent to the tube. The sample is dissolved in the solvent in a thermostat at 40° C. to prepare a solution.

In the resultant ¹H-NMR chart, a peak independent of a peak assigned to a constituent for any other monomer unit is selected from peaks assigned to constituents for the monomer unit (a), and the integrated value S₁ of the peak is calculated. Similarly, in the resultant ¹H-NMR chart, a peak independent of a peak assigned to a constituent for any other monomer unit is selected from peaks assigned to constituents for the monomer unit (b), and the integrated value S₂ of the peak is calculated.

Further, when the third and fourth monomer units are contained, a peak independent of a peak assigned to a constituent for any other monomer unit is selected from peaks assigned to constituents for the third and fourth monomer units, and the integrated values S3 and S4 of the peaks are calculated.

The ratio of the monomer unit (a) is determined by using the integrated values S₁, S₂, S₃, and S₄ as described below. n₁, n₂, n₃, and n₄ each represent the number of hydrogen atoms in the constituent to which the peak to which attention has been paid for the corresponding moiety is assigned.

Ratio(mol %) of monomer unit (a)={(S₁/n₁)/((S₁/n₁)+(S₂/n₂)+(S₃/n₃)+(S₄/n₄))}×100

Similarly, the ratio of the monomer unit (b) and the third and fourth monomer units are determined as described below.

Ratio(mol %) of monomer unit (b)={(S₂/n₂)/((S₁/n₁)+(S₂/n₂)+(S₃/n₃)+(S₄/n₄))}×100

Ratio(mol %) of third monomer unit={(S₃/n₃)/((S₁/n₁)+(S₂/n₂)±(S₃/n₃)+(S₄/n₄))}×100

Ratio(mol %) of fourth monomer unit={(S₄/n₄)/((S₁/n₁)+(S₂/n₂)+(S₃/n₃)+(S₄/n₄))}×100

When a polymerizable monomer in which a constituent except a vinyl group is free of any hydrogen atom is used in the binder resin, the measurement is performed by using ¹³C-NMR through use of ¹³C as a measurement atomic nucleus in a single-pulse mode, and the calculation is similarly performed by ¹H-NMR. In addition, when the toner is produced by a suspension polymerization method, the peaks of the release agent and a resin for a shell may overlap each other to preclude the observation of independent peaks. As a result, there occurs a case in which the ratio of the various units contained in the binder resin cannot be calculated. In that case, the analysis may be performed by: performing the same suspension polymerization without use of the release agent and any other resin to produce a binder resin′; and regarding the binder resin′ as the binder resin.

<Method of measuring Polymerization Conversion Ratio of Polymerizable Monomer>

The polymerization conversion ratio of a polymerizable monomer is measured by using gas chromatography (GC) as described below. 500 mg of a toner particle dispersion liquid is precisely weighed and loaded into a sample bottle. To the liquid, 10 g of acetone that has been precisely weighed is added, and the bottle is lidded. After that, the contents are sufficiently mixed and irradiated with an ultrasonic wave by using a desktop ultrasonic cleaner (product name: “B2510J-MTH”, manufactured by BRANSON Corporation) having an oscillatory frequency of 42 kHz and an electrical output of 125 W for 30 minutes. After that, the mixture is filtered with a solvent-resistant membrane filter “MYSHORI DISK” (manufactured by Tosoh Corporation) having a pore diameter of 0.2 μm, and 2 μL of the filtrate is analyzed by gas chromatography.
GC: 6890 GC manufactured by Hewlett-Packard Company
Column: INNOWax (200 μm×0.40 μm×25 m) manufactured by Hewlett-Packard Company
Carrier gas: He (constant pressure mode: 20 psi)
Oven: (1) Its temperature is held at 50° C. for 10 minutes, (2) the temperature is increased to 200° C. at 10° C./min, and (3) the temperature is held at 200° C. for 5 minutes.
Inlet: 200° C., pulsed splitless mode (20 to 40 psi, until 0.5 minute)
Split ratio: 5.0:1.0
Detector: 250° C. (FID)

Then, the “remaining amount” of the remaining polymerizable monomer is calculated from a calibration curve produced by using the used polymerizable monomer in advance. After that, the polymerization conversion ratio (% by mass) of the polymerizable monomer is specified in accordance with the following equation. Polymerization conversion ratio (% by mass)=100×(1−(remaining amount of polymerizable monomer)/(total amount of used polymerizable monomer))

In addition, in the case of a polymerizable monomer that cannot be detected by gas chromatography (e.g., behenyl acrylate), its polymerization conversion ratio is measured by using gel permeation chromatography (GPC) as described below. First, about 500 mg of a toner particle dispersion liquid during its polymerization is precisely weighed and loaded into a sample bottle. The liquid is dissolved in about 10 g of tetrahydrofuran (THF) that has been precisely weighed. Then, the resultant solution is filtered with a solvent-resistant membrane filter “MYSHORI DISK” (manufactured by Tosoh Corporation) having a pore diameter of 0.2 μm to provide a sample solution. Measurement is performed with the sample solution under the following conditions.
Apparatus: HLC 8120 GPC (detector: RI) (manufactured by Tosoh Corporation)
Column: Septuplicate of Shodex KF-801, 802, 803, 804, 805, 806, and 807 (manufactured by Showa Denko K.K.)
Eluent: Tetrahydrofuran (THF)
Flow rate: 1.0 ml/min
Oven temperature: 40.0° C.
Sample injection amount: 0.10 ml

### EXAMPLES

The present disclosure is more specifically described below by way of Examples. However, the invention is by no means limited by these Examples. In the following formulations, the term “part(s)” means “part(s) by mass” unless otherwise stated.

### Example 1

### [Production of Toner by Suspension Polymerization Method]

### (Production of Toner Particles 1)

A mixture formed of the following materials was prepared.

| | | |
|---|---|---|
| Methacrylonitrile (the polymerizable monomer B; | 30.0 | parts |
| corresponding to the unit (b)) | | |
| Styrene | 13.0 | parts |
| Ethyl methacrylate | 7.0 | parts |
| Aluminum di-t-butylsalicylate | 1.0 | part |
| Colorant (carbon black) | 8.0 | parts |

The mixture was loaded into an attritor (manufactured by Nippon Coke & Engineering Co., Ltd.) and dispersed with zirconia beads each having a diameter of 5 mm at 200 rpm for 2 hours to provide a raw material dispersion liquid.

Meanwhile, 735.0 parts of ion-exchanged water and 16.0 parts of trisodium phosphate (dodecahydrate) were added to a vessel including a high-speed stirring device HOMOMIXER (manufactured by PRIMIX Corporation) and a temperature gauge, and a temperature in the vessel was increased to 60° C. while the mixture was stirred at 12,000 rpm. An aqueous solution of calcium chloride obtained by dissolving 9.0 parts of calcium chloride (dihydrate) in 65.0 parts of ion-exchanged water was loaded into the vessel, and the mixture was stirred at 12,000 rpm for 30 minutes while the temperature was maintained at 60° C. 10% hydrochloric acid was added to the mixture to adjust its pH to 6.0. Thus, such an aqueous medium that an inorganic dispersion stabilizer containing hydroxyapatite was dispersed in water was obtained.

Subsequently, the above-mentioned raw material dispersion liquid was transferred to a vessel including a stirring device and a temperature gauge, and a temperature in the vessel was increased to 60° C. while the liquid was stirred at 100 rpm. The following materials were added to the vessel, and the mixture was stirred at 100 rpm for 30 minutes while the temperature was maintained at 60° C.

| | |
|---|---|
| Behenyl acrylate (the polymerizable monomer A; | 50.0 parts |
| corresponding to the unit (a)) | |
| Release agent 1 (Release agent 1: DP18 (dipentaerythritol | 10.0 parts |
| stearic acid ester wax, melting point: 79° C., manufactured | |
| by Nippon Seiro Co., Ltd.)) | |

After that, 7.0 parts of t-butyl peroxypivalate (manufactured by NOF Corporation: PERBUTYL PV) serving as an oil-soluble polymerization initiator 1 and 1.0 part of t-butyl peroxyisobutyrate (manufactured by ARKEMA Yoshitomi, Ltd.: L80) serving as an oil-soluble polymerization initiator 2 were added to the vessel, and the mixture was further stirred for 1 minute. After that, the mixture was loaded into the aqueous medium stirred with the above-mentioned high-speed stirring device at 12,000 rpm. The mixture was continuously stirred with the high-speed stirring device at 12,000 rpm for 20 minutes while the temperature was maintained at 60° C. Thus, a granulated liquid was obtained.

The above-mentioned granulated liquid was transferred to a reaction vessel including a reflux condenser, a stirring machine, a temperature gauge, and a nitrogen-introducing tube, and a first-stage polymerization reaction was performed at 150 rpm by increasing a temperature in the vessel to 70° C. while stirring the liquid at 150 rpm under a nitrogen atmosphere. As a water-soluble polymerization initiator, 1.0 part of potassium persulfate (KPS) was added when the polymerization conversion ratio of the polymerizable monomer A and the polymerization conversion ratio of the polymerizable monomer B, the polymerization conversion ratios being measured in advance while the reaction was performed, became 50% by mass and 80% by mass, respectively. The holding time of the first-stage polymerization reaction was set to 5 hours. After that, the temperature was increased to 90° C., and a second polymerization reaction was performed for 4 hours while the temperature was held at 90° C. Further, the temperature was increased to 99° C., and a third polymerization reaction was performed for 3 hours while the temperature was held at 99° C. Thus, a toner particle dispersion liquid was obtained.

The resultant toner particle dispersion liquid was cooled to 45° C. while being stirred at 150 rpm. After that, the liquid was thermally treated for 5 hours while its temperature was maintained at 45° C. After that, while the stirring was continued, dilute hydrochloric acid was added until the pH of the liquid became 1.5. Thus, the dispersion stabilizer was dissolved. The solid content was separated by filtration, and was sufficiently washed with ion-exchanged water, followed by vacuum drying at 30° C. for 24 hours. Thus, toner particles 1 having a weight-average particle diameter (D4) of 6.4 μm were obtained.

(Preparation of Toner 1)

As an external additive, 2.0 parts of silica fine particles (subjected to hydrophobic treatment with hexamethyldisilazane, number-average particle diameter of primary particles: 10 nm, BET specific surface area: 170 m²/g) were added to 100.0 parts of the above-mentioned toner particles 1, and the materials were mixed with a Henschel mixer (manufactured by Nippon Coke & Engineering Co., Ltd.) at 3,000 rpm for 15 minutes to provide a toner 1. The physical properties of the resultant toner 1 are shown in Tables 3 to 5.

### Examples 2 to 8 and 10 to 17

Toner particles 2 to 8 and 10 to 17 were each obtained in exactly the same manner as in the production of the toner 1 of Example 1 except that the kinds and addition amounts of the polymerizable monomers to be used, the kinds and addition amounts of the oil-soluble polymerization initiators and the water-soluble polymerization initiator, and the polymerization conditions were changed as shown in Tables 1 and 2.

Further, the same external addition as that of the toner particles 1 was performed to provide toners 2 to 8 and 10 to 17. The physical properties of the resultant toners are shown in Tables 3 to 5.

### Example 9

### (Production of Toner Particles 9)

A mixture formed of the following materials was prepared.

| | | |
|---|---|---|
| Methacrylonitrile (the polymerizable monomer B; | 30.0 | parts |
| corresponding to the unit (b)) | | |
| Styrene | 13.0 | parts |
| Ethyl methacrylate | 7.0 | parts |
| Aluminum di-t-butylsalicylate | 1.0 | part |
| Colorant (carbon black) | 8.0 | parts |

The mixture was loaded into an attritor (manufactured by Nippon Coke & Engineering Co., Ltd.) and dispersed with zirconia beads each having a diameter of 5 mm at 200 rpm for 2 hours to provide a raw material dispersion liquid.

Meanwhile, 735.0 parts of ion-exchanged water and 16.0 parts of trisodium phosphate (dodecahydrate) were added to a vessel including a high-speed stirring device HOMOMIXER (manufactured by PRIMIX Corporation) and a temperature gauge, and a temperature in the vessel was increased to 60° C. while the mixture was stirred at 12,000 rpm. An aqueous solution of calcium chloride obtained by dissolving 9.0 parts of calcium chloride (dihydrate) in 65.0 parts of ion-exchanged water was loaded into the vessel, and the mixture was stirred at 12,000 rpm for 30 minutes while the temperature was maintained at 60° C. To the mixture, 10% hydrochloric acid was added to adjust its pH to 6.0. Thus, such an aqueous medium that an inorganic dispersion stabilizer containing hydroxyapatite was dispersed in water was obtained.

Subsequently, the above-mentioned raw material dispersion liquid was transferred to a vessel including a stirring device and a temperature gauge, and a temperature in the vessel was increased to 60° C. while the liquid was stirred at 100 rpm. The following materials were added to the vessel, and the mixture was stirred at 100 rpm for 30 minutes while the temperature was maintained at 60° C.

| | |
|---|---|
| Behenyl acrylate (the polymerizable monomer A; | 49.0 parts |
| corresponding to the unit (a)) | |
| Release agent 1 (Release agent 1: DP18 (dipentaerythritol | 10.0 parts |
| stearic acid ester wax, melting point: 79° C., manufactured | |
| by Nippon Seiro Co., Ltd.)) | |

After that, 7.0 parts of t-butyl peroxypivalate (manufactured by NOF Corporation: PERBUTYL PV) serving as an oil-soluble polymerization initiator 1 and 1.0 part of t-butyl peroxyisobutyrate (manufactured by ARKEMA Yoshitomi, Ltd.: L80) serving as an oil-soluble polymerization initiator 2 were added to the vessel, and the mixture was further stirred for 1 minute. After that, the mixture was loaded into the aqueous medium stirred with the above-mentioned high-speed stirring device at 12,000 rpm. The mixture was continuously stirred with the high-speed stirring device at 12,000 rpm for 20 minutes while the temperature was maintained at 60° C. Thus, a granulated liquid was obtained.

The above-mentioned granulated liquid was transferred to a reaction vessel including a reflux condenser, a stirring machine, a temperature gauge, and a nitrogen-introducing tube, and a first-stage polymerization reaction was performed at 150 rpm by increasing a temperature in the vessel to 70° C. while stirring the liquid at 150 rpm under a nitrogen atmosphere. After the stirring had been performed for 2 hours, 2.0 parts of methacrylonitrile was added to the resultant, and the mixture was stirred for 5 minutes. As a water-soluble polymerization initiator, 1.0 part of potassium persulfate (KPS) was further added when the polymerization conversion ratio of the polymerizable monomer A and the polymerization conversion ratio of the polymerizable monomer B, the polymerization conversion ratios being measured in advance while the reaction was performed, became 50% by mass and 75% by mass, respectively. The holding time of the first-stage polymerization reaction was set to a total of 5 hours. After that, the temperature was increased to 90° C., and a second polymerization reaction was performed for 4 hours while the temperature was held at 90° C. Further, the temperature was increased to 99° C., and a third polymerization reaction was performed for 3 hours while the temperature was held at 99° C. Thus, a toner particle dispersion liquid was obtained.

The resultant toner particle dispersion liquid was cooled to 45° C. while being stirred at 150 rpm. After that, the liquid was thermally treated for 5 hours while its temperature was maintained at 45° C. After that, while the stirring was continued, dilute hydrochloric acid was added until the pH of the liquid became 1.5. Thus, the dispersion stabilizer was dissolved. The solid content was separated by filtration, and was sufficiently washed with ion-exchanged water, followed by vacuum drying at 30° C. for 24 hours. Thus, toner particles 9 were obtained.

(Preparation of Toner 9)

As an external additive, 2.0 Parts of silica fine particles (subjected to hydrophobic treatment with hexamethyldisilazane, number-average particle diameter of primary particles: 10 nm, BET specific surface area: 170 m²/g) were added to 100.0 parts of the above-mentioned toner particles 9, and the materials were mixed with a Henschel mixer (manufactured by Nippon Coke & Engineering Co., Ltd.) at 3,000 rpm for 15 minutes to provide a toner 9. The physical properties of the resultant toner are shown in Tables 3 and 4.

### Comparative Example 1

### (Production Example of Crystalline Polyester A)

In a reaction vessel including a stirring machine, a temperature gauge, a nitrogen-introducing tube, and a decompression device, 100 parts of xylene was heated while the inside of the vessel was purged with nitrogen, followed by refluxing at a liquid temperature of 140° C. A mixture containing 100 parts of styrene and 8.00 parts of dimethyl 2,2′-azobis(2-methylpropionate) serving as a polymerization initiator was dropped into the solution over 3 hours. After the completion of the dropping, the solution was stirred for 3 hours. After that, xylene and residual styrene were distilled off at 160° C. and 1 hPa. Thus, a vinyl polymer was obtained.

Next, the following materials were added to a reaction vessel including a stirring machine, a temperature gauge, a nitrogen-introducing tube, a dewatering tube, and a decompression device, and were caused to react with each other under a nitrogen atmosphere at 150° C. for 4 hours.

| | | |
|---|---|---|
| Vinyl polymer obtained in the foregoing | 95.1 | parts |
| Xylene serving as an organic solvent | 120.0 | parts |
| 1,12-Dodecanediol | 78.6 | parts |
| Titanium(IV) isopropoxide serving as an | 0.500 | part |
| esterification catalyst | | |

After that, 65.5 parts of sebacic acid was added to the resultant, and the materials were caused to react with each other at 150° C. for 3 hours.

Further, 9.5 parts of stearic acid was added to the resultant, and the materials were caused to react with each other at 180° C. for 4 hours.

After that, the resultant was further subjected to a reaction at 180° C. and 1 hPa until a desired acid value and a desired hydroxyl value were obtained. Thus, a crystalline polyester A was obtained.

(Production Example of Polar Resin A)

Into an autoclave including a stirring machine, a temperature gauge, a nitrogen-introducing tube, a decompression device, and a dewatering tube, 300 parts of xylene was loaded and was heated while the inside of the vessel was purged with nitrogen, followed by refluxing at a liquid temperature of 140° C. A mixed liquid containing the following materials was added to the autoclave, and then the mixture was polymerized at a polymerization temperature of 160° C. and a pressure at the time of the reaction of 0.150 MPa for 5 hours.

| | | |
|---|---|---|
| Styrene | 91.50 | parts |
| Butyl acrylate | 1.00 | part |
| Methyl methacrylate | 2.50 | parts |
| Methacrylic acid | 2.50 | parts |
| 2-Hydroxyethyl methacrylate | 2.50 | parts |
| Polymerization initiator (di-tert-butyl peroxide) | 2.00 | parts |

After that, a desolvation step was performed under reduced pressure for 3 hours to remove xylene, and the residue was pulverized to provide a polar resin A.

(Production of Toner 18)

The following materials were added to a four-necked vessel including a reflux condenser, a stirring machine, a temperature gauge, and a nitrogen-introducing tube, and a temperature in the vessel was held at 60° C. while the mixture was stirred with a high-speed stirring device T.K. HOMOMIXER (manufactured by Tokushu Kika Kogyo Co., Ltd.) at 12,000 rpm.

| | | |
|---|---|---|
| Ion-exchanged water | 700 | parts |
| 0.1 mol/l aqueous solution of Na₃PO₄ | 1,000 | parts |
| 1.0 mol/l aqueous solution of HCl | 24.0 | parts |

To the resultant, 85 parts of a 1.0 mol/1 aqueous solution of CaCl₂) was gradually added to prepare an aqueous dispersion medium containing a fine and hardly water-soluble dispersion stabilizer Ca₃(PO₄)₂.

| | | |
|---|---|---|
| Styrene monomer | 75.5 | parts |
| n-Butyl acrylate | 24.5 | parts |
| Crystalline polyester A | 27.0 | parts |
| Polar resin A | 10.0 | parts |
| Release agent (behenyl behenate) | 10.0 | parts |
| Carbon black | 8.0 | parts |
| Charge control agent (BONTRON E-88, manufactured | 0.7 | part |

by Orient Chemical Industries Co., Ltd., aluminum
3:1 type compound of 3,5-di-tert-butylsalicylic acid)

A polymerizable monomer composition 1 obtained by dispersing the above-mentioned materials with an attritor (manufactured by Mitsui Miike Chemical Machinery Co., Ltd.) for 3 hours was held at a temperature of 60° C. for 20 minutes. After that, 10.0 parts of t-butyl peroxypivalate (70% toluene solution) serving as a polymerization initiator was added to the polymerizable monomer composition 1, and the polymerizable monomer composition 1 was loaded into the aqueous dispersion medium, followed by granulation for 10 minutes while the number of revolutions of the high-speed stirring device was maintained at 12,000 rpm. After that, the high-speed stirring device was changed to a propeller-type stirring unit, and the temperature in the vessel was increased to 70° C., and the resultant was subjected to a reaction for 5 hours while being slowly stirred. At this time, the pH of the aqueous dispersion medium was 5.1. Next, the temperature in the vessel was increased to 85° C., and was maintained for 5 hours. After that, the reflux condenser was removed, and a distilling device was mounted on the vessel to perform distillation at a temperature in the vessel of 100° C. for 5 hours. The resultant was cooled to 30° C., and then 10% hydrochloric acid was added to remove the dispersion stabilizer. Further, the solid content was separated by filtration, washed, and dried to provide toner particles 18 having a weight-average particle diameter (D4) of 6.4

A toner 18 was provided by mixing 100 parts of the toner particles 18 and 1.6 parts of hydrophobic silica fine powder that had a BET value of 300 m²/g and whose primary particles had a number-average particle diameter of 8 nm, with MITSUI HENSCHEL MIXER (manufactured by Mitsui Miike Chemical Machinery Co., Ltd.). The physical properties of the resultant toner 18 are shown in Tables 3 and 4.

### Comparative Example 2

### (Production of Toner Particles 19)

A mixture formed of the following materials was prepared.

| | | |
|---|---|---|
| Methacrylonitrile (the polymerizable monomer B; | 30.0 | parts |
| corresponding to the unit (b)) | | |
| Styrene | 13.0 | parts |
| Ethyl methacrylate | 7.0 | parts |
| Aluminum di-t-butylsalicylate | 1.0 | part |
| Colorant (carbon black) | 8.0 | parts |

The mixture was loaded into an attritor (manufactured by Nippon Coke & Engineering Co., Ltd.) and dispersed with zirconia beads each having a diameter of 5 mm at 200 rpm for 2 hours to provide a raw material dispersion liquid.

Meanwhile, 735.0 parts of ion-exchanged water and 16.0 parts of trisodium phosphate (dodecahydrate) were added to a vessel including a high-speed stirring device HOMOMIXER (manufactured by PRIMIX Corporation) and a temperature gauge, and a temperature in the vessel was increased to 60° C. while the mixture was stirred at 12,000 rpm. An aqueous solution of calcium chloride obtained by dissolving 9.0 parts of calcium chloride (dihydrate) in 65.0 parts of ion-exchanged water was loaded into the vessel, and the mixture was stirred at 12,000 rpm for 30 minutes while the temperature was maintained at 60° C. To the mixture, 10% hydrochloric acid was added to adjust its pH to 6.0. Thus, such an aqueous medium that an inorganic dispersion stabilizer containing hydroxyapatite was dispersed in water was obtained.

Subsequently, the above-mentioned raw material dispersion liquid was transferred to a vessel including a stirring device and a temperature gauge, and a temperature in the vessel was increased to 60° C. while the liquid was stirred at 100 rpm. The following materials were added to the vessel, and the mixture was stirred at 100 rpm for 30 minutes while the temperature was maintained at 60° C.

| | |
|---|---|
| Behenyl acrylate (the polymerizable monomer A; | 50.0 parts |
| corresponding to the unit (a)) | |
| Release agent 1 (Release agent 1: DP18 (dipentaerythritol | 10.0 parts |
| stearic acid ester wax, melting point: 79° C., manufactured | |
| by Nippon Seiro Co., Ltd.)) | |

After that, 7.0 parts of t-butyl peroxypivalate (manufactured by NOF Corporation: PERBUTYL PV) serving as an oil-soluble polymerization initiator 1 and 1.0 part of t-butyl peroxyisobutyrate (manufactured by ARKEMA Yoshitomi, Ltd.: L80) serving as an oil-soluble polymerization initiator 2 were added to the vessel, and the mixture was further stirred for 1 minute. After that, the mixture was loaded into the aqueous medium stirred with the above-mentioned high-speed stirring device at 12,000 rpm. The mixture was continuously stirred with the high-speed stirring device at 12,000 rpm for 20 minutes while the temperature was maintained at 60° C. Thus, a granulated liquid was obtained.

The above-mentioned granulated liquid was transferred to a reaction vessel including a reflux condenser, a stirring machine, a temperature gauge, and a nitrogen-introducing tube, and a first-stage polymerization reaction was performed at 150 rpm for 5 hours by increasing a temperature in the vessel to 70° C. while stirring the liquid at 150 rpm under a nitrogen atmosphere. After that, the temperature was increased to 90° C., and a second polymerization reaction was performed for 4 hours while the temperature was held at 90° C. Further, the temperature was increased to 99° C., and a third polymerization reaction was performed for 3 hours while the temperature was held at 99° C. Thus, a toner particle dispersion liquid was obtained.

The resultant toner particle dispersion liquid was cooled to 45° C. while being stirred at 150 rpm. After that, the liquid was thermally treated for 5 hours while its temperature was maintained at 45° C. After that, while the stirring was continued, dilute hydrochloric acid was added until the pH of the liquid became 1.5. Thus, the dispersion stabilizer was dissolved. The solid content was separated by filtration, and was sufficiently washed with ion-exchanged water, followed by vacuum drying at 30° C. for 24 hours. Thus, toner particles 19 were obtained.

(Preparation of Toner 19)

As an external additive, 2.0 parts of silica fine particles (subjected to hydrophobic treatment with hexamethyldisilazane, number-average particle diameter of primary particles: 10 nm, BET specific surface area: 170 m²/g) were added to 100.0 parts of the above-mentioned toner particles 19, and the materials were mixed with a Henschel mixer (manufactured by Nippon Coke & Engineering Co., Ltd.) at 3,000 rpm for 15 minutes to provide a toner 19. The physical properties of the resultant toner 19 are shown in Tables 3 and 4.

### Comparative Examples 3

### (Production of Toner 20)

Toner particles 20 were obtained in exactly the same manner as in the production of the toner 1 except that the kinds and addition amounts of the polymerizable monomers to be used, the kinds and addition amounts of the oil-soluble polymerization initiators and the water-soluble polymerization initiator, and the polymerization conditions were changed as shown in Tables 1 and 2.

Further, the same external addition as that of the toner particles 1 was performed to provide a toner 20. The physical properties of the resultant toner 20 are shown in Tables 3 and 4.

### Comparative Example 4

### [Production of Toner 21 by Emulsion Aggregation Method]

### (Production of Resin Particle Dispersion Liquid 1)

| | | |
|---|---|---|
| Styrene | 280.0 | parts |
| Methacrylonitrile | 220.0 | parts |
| Stearyl acrylate | 500.0 | parts |
| Dodecylmercaptan | 6.0 | parts |
| Decanediol acrylic acid ester | 4.0 | parts |

The above-mentioned materials were mixed and dissolved. The solution was dispersed and emulsified in a solution obtained by dissolving 20.0 parts of an anionic surfactant NEWREX PASTE H (manufactured by NOF Corporation) in 1,300.0 parts of ion-exchanged water in a flask. While the emulsion was stirred for 10 minutes, 200.0 parts of ion-exchanged water having dissolved therein 20.0 parts of ammonium persulfate was loaded into the emulsion, and the inside of the flask was purged with nitrogen. After that, emulsion polymerization was performed for 6 hours by heating the contents to 70° C. After that, the reaction liquid was cooled to room temperature to produce a resin particle dispersion liquid 1.

(Production of Resin Particle Dispersion Liquid 2)

| | | |
|---|---|---|
| Styrene | 280.0 | parts |
| Methacrylonitrile | 220.0 | parts |
| Stearyl acrylate | 500.0 | parts |
| Acrylic acid | 20.0 | parts |
| Dodecylmercaptan | 12.0 | parts |
| Decanediol acrylic acid ester | 4.0 | parts |

The above-mentioned materials were mixed and dissolved. The solution was dispersed and emulsified in a solution obtained by dissolving 20.0 parts of an anionic surfactant NEWREX PASTE H (manufactured by NOF Corporation) in 1,300.0 parts of ion-exchanged water in a flask. While the emulsion was stirred for 10 minutes, 200.0 parts of ion-exchanged water having dissolved therein 20.0 parts of ammonium persulfate was loaded into the emulsion, and the inside of the flask was purged with nitrogen. After that, emulsion polymerization was performed for 6 hours by heating the contents to 70° C. After that, the reaction liquid was cooled to room temperature to produce a resin particle dispersion liquid 2.

(Preparation of Colorant Dispersion Liquid)

| | |
|---|---|
| Phthalocyanine pigment (manufactured by Dainichiseika | 250 parts |
| Color & Chemicals Mfg. Co., Ltd.: PV FAST BLUE) | |
| Anionic surfactant (manufactured by DKS Co. Ltd.: | 20 parts |
| NEOGEN RK) | |
| Ion-exchanged water | 730 parts |

The above-mentioned materials were mixed and dissolved, and were then dispersed with a homogenizer (ULTRA-TURRAX manufactured by IKA Company) to provide a colorant dispersion liquid.

(Preparation of Release Agent Particle Dispersion Liquid)

| | |
|---|---|
| Polyethylene wax (manufactured by Toyo | 400 parts |
| Petrolite Corporation: Polywax 725) | |
| Anionic surfactant (manufactured by NOF | 20 parts |
| Corporation: NEWREX R) | |
| Ion-exchanged water | 580 parts |

The above-mentioned materials were mixed and dissolved, and were then dispersed with a homogenizer (manufactured by IKA Company: ULTRA-TURRAX). After that, the resultant was subjected to dispersion treatment with a pressure discharge-type homogenizer to prepare a release agent particle dispersion liquid having dispersed therein release agent particles (polyethylene wax).

(Preparation of Dispersion Liquid of Resin Particles for Shell)

The following materials were loaded into a reaction vessel including a reflux condenser, a stirring machine, and a nitrogen-introducing tube under a nitrogen atmosphere.

| | | |
|---|---|---|
| Toluene | 100.0 | parts |
| Styrene (St) | 84.5 | parts |
| n-Butyl acrylate (BA) | 11.3 | parts |
| Methyl methacrylate (MMA) | 2.5 | parts |
| Methacrylic acid (MAA) | 1.7 | parts |
| t-Butyl peroxypivalate | 3.0 | parts |

The mixture in the vessel was stirred at 200 revolutions per minute, and was heated to 70° C., followed by stirring for 10 hours. Further, the mixture was heated to 100° C., and was polymerized for 6 hours. After that, the solvent was distilled off. Thus, a shell resin 1 was obtained. The shell resin 1 had a Tg of 71° C., a SP value of 9.9, and a peak molecular weight (Mp) of 15,000.

The following raw materials were loaded into a reaction vessel including a stirring machine, a reflux condenser, a temperature gauge, and a nitrogen-introducing tube, and were heated to a temperature of 80° C. to be dissolved.

| | | |
|---|---|---|
| Shell resin 1 | 100.0 | parts |
| Methyl ethyl ketone | 45.0 | parts |
| Tetrahydrofuran | 45.0 | parts |
| Diethylaminoethanol | 1.0 | part |

Next, 300.0 parts of ion-exchanged water at a temperature of 80° C. was gently added to the solution under stirring to perform phase inversion emulsification. After that, the resultant aqueous dispersion was transferred to a distilling device, and distillation was performed until a fraction temperature reached 100° C.

Ion-exchanged water was added to the resultant water dispersion after its cooling to adjust the concentration of the shell resin in a dispersion liquid to be obtained to 20%. The mixture was adopted as a shell resin dispersion liquid 1. Part of the shell resin dispersion liquid 1 was removed, and the median diameter (D50) of its particles on a volume basis was measured. As a result, the median diameter was 480 nm.

(Production of Toner Particles 21)

| | | |
|---|---|---|
| Resin particle dispersion liquid 1 | 900.0 | parts |
| Resin particle dispersion liquid 2 | 225.0 | parts |
| Colorant particle dispersion liquid | 100.0 | parts |
| Release agent particle dispersion liquid | 63.0 | parts |
| Aluminum sulfate (manufactured by Wako | 5.0 | parts |
| Pure Chemical Industries, Ltd.) | | |
| Ion-exchanged water | 1,000.0 | parts |

The above-mentioned materials were stored in a round-bottom flask made of stainless steel, and their pH was adjusted to 2.0. After that, the materials were dispersed with a homogenizer (manufactured by IKA Company: ULTRA-TURRAX T50), and were then heated to 64° C. while being stirred in an oil bath for heating. The resultant dispersion liquid was held at 61° C. for 3 hours, and was then observed with an optical microscope. As a result, it was recognized that aggregated particles having an average particle diameter of about 5.0 μm were formed. The stirring under heating was further continued for 4 hours at 61° C., and then the resultant dispersion liquid was observed with the optical microscope. As a result, it was recognized that aggregated particles having an average particle diameter of about 5.4 μm were formed.

Ion-exchanged water was added to the resultant dispersion liquid to adjust the concentration of the resins in the dispersion liquid to 20%. Thus, a core particle dispersion liquid was obtained.

Into 500.0 parts (solid content: 100.0 parts) of the core particle dispersion liquid, 6 parts of a 10% aqueous solution of polyaluminum chloride was dropped. After that, 50 parts (solid content: 10.0 parts) of the shell resin dispersion liquid 1 was added to the mixture to adjust its pH to 4, and the whole was continuously stirred for 30 minutes. The suspension liquid was warmed to 71° C., and was further continuously stirred for 3 hours. After that, the suspension liquid was filtered and sufficiently washed with ion-exchanged water, and the washed product was dried with a vacuum dryer to provide toner particles 21.

(Preparation of Toner 21)

As an external additive, 2.0 Parts of silica fine particles (subjected to hydrophobic treatment with hexamethyldisilazane, number-average particle diameter of primary particles: 10 nm, BET specific surface area: 170 m²/g) were added to 100.0 parts of the above-mentioned toner particles 21, and the materials were mixed with a Henschel mixer (manufactured by Nippon Coke & Engineering Co., Ltd.) at 3,000 rpm for 15 minutes to provide a toner 21. The physical properties of the resultant toner 21 are shown in Tables 3 and 4.

TABLE 1

| | | Binder resin | | | | | | | |
|---|---|---|---|---|---|---|---|---|---|
| | | Polymerizable monomer A | | Polymerizable monomer B | | Third polymerizable monomer | | Fourth polymerizable monomer | |
| | | | Addition | | Addition | | Addition | | Addition |
| | | | amount | | amount | | amount | | amount |
| | | Kind | [part(s)] | Kind | [part(s)] | Kind | [part(s)] | Kind | [part(s)] |
| Example 1 | Toner 1 | Behenyl | 50.0 | Methacrylonitrile | 30.0 | Styrene | 13.0 | Ethyl | 7.0 |
| | | acrylate | | | | | | methacrylate | |
| Example 2 | Toner 2 | Behenyl | 45.0 | Methacrylonitrile | 35.0 | Styrene | 13.0 | Ethyl | 7.0 |
| | | acrylate | | | | | | methacrylate | |
| Example 3 | Toner 3 | Behenyl | 38.0 | Methacrylonitrile | 30.0 | Styrene | 17.0 | Ethyl | 15.0 |
| | | acrylate | | | | | | methacrylate | |
| Example 4 | Toner 4 | Behenyl | 42.0 | Methacrylonitrile | 30.0 | Styrene | 18.0 | Ethyl | 10.0 |
| | | acrylate | | | | | | methacrylate | |
| Example 5 | Toner 5 | Behenyl | 78.0 | Methacrylonitrile | 12.0 | Styrene | 7.0 | Ethyl | 3.0 |
| | | acrylate | | | | | | methacrylate | |
| Example 6 | Toner 6 | Behenyl | 82.0 | Methacrylonitrile | 10.0 | Styrene | 6.0 | Ethyl | 2.0 |
| | | acrylate | | | | | | methacrylate | |
| Example 7 | Toner 7 | Behenyl | 50.0 | Methacrylonitrile | 30.0 | Styrene | 13.0 | Ethyl | 7.0 |
| | | acrylate | | | | | | methacrylate | |
| Example 8 | Toner 8 | Behenyl | 50.0 | Methacrylonitrile | 30.0 | Styrene | 13.0 | Ethyl | 7.0 |
| | | acrylate | | | | | | methacrylate | |
| Example 9 | Toner 9 | Behenyl | 49.0 | Methacrylonitrile | 30.0 | Styrene | 13.0 | Ethyl | 7.0 |
| | | acrylate | | | | | | methacrylate | |
| Example 10 | Toner 10 | Behenyl | 50.0 | Methacrylonitrile | 30.0 | Styrene | 13.0 | Ethyl | 7.0 |
| | | acrylate | | | | | | methacrylate | |
| Example 11 | Toner 11 | Behenyl | 50.0 | Methacrylonitrile | 30.0 | Styrene | 13.0 | Ethyl | 7.0 |
| | | acrylate | | | | | | methacrylate | |
| Example 12 | Toner 12 | Behenyl | 50.0 | Methacrylonitrile | 30.0 | Styrene | 13.0 | Ethyl | 7.0 |
| | | acrylate | | | | | | methacrylate | |
| Example 13 | Toner 13 | Behenyl | 50.0 | Acrylonitrile | 30.0 | Styrene | 13.0 | Ethyl | 7.0 |
| | | acrylate | | | | | | methacrylate | |
| Example 14 | Toner 14 | Stearyl | 50.0 | Methacrylonitrile | 30.0 | Styrene | 13.0 | Ethyl | 7.0 |
| | | acrylate | | | | | | methacrylate | |
| Example 15 | Toner 15 | Myricyl | 50.0 | Methacrylonitrile | 30.0 | Styrene | 13.0 | Ethyl | 7.0 |
| | | acrylate | | | | | | methacrylate | |
| Example 16 | Toner 16 | Behenyl | 50.0 | Methacrylonitrile | 30.0 | Styrene | 13.0 | Ethyl | 7.0 |
| | | acrylate | | | | | | methacrylate | |
| Example 17 | Toner 17 | Behenyl | 50.0 | Methacrylonitrile | 30.0 | Styrene | 13.0 | Ethyl | 7.0 |
| | | acrylate | | | | | | methacrylate | |
| Comparative | Toner 18 | Described in production example of toner particles 18 | | | | | | | |
| Example 1 | | | | | | | | | |
| Comparative | Toner 19 | Behenyl | 50.0 | Methacrylonitrile | 30.0 | Styrene | 13.0 | Ethyl | 7.0 |
| Example 2 | | acrylate | | | | | | methacrylate | |
| Comparative | Toner 20 | Behenyl | 90.0 | Methacrylonitrile | 10.0 | — | — | — | — |
| Example 3 | | acrylate | | | | | | | |
| Comparative | Toner 21 | Described in production example of toner particles 21 | | | | | | | |
| Example 4 | | | | | | | | | |

TABLE 2

| | | | | | | | | Timing at which water-soluble | |
|---|---|---|---|---|---|---|---|---|---|
| | | Initiator | | | | | | polymerization initiator is added | |
| | | Oil-soluble | | Oil-soluble | | Water-soluble | | Polymerization | Polymerization |
| | | polymerization | | polymerization | | polymerization | | conversion | conversion |
| | | initiator 1 | | initiator 2 | | initiator | | ratio of | ratio of |
| | | | Addition | | Addition | | Addition | polymerizable | polymerizable |
| | Toner | | amount | | amount | | amount | monomer (A) | monomer (B) |
| | No. | Kind | [part(s)] | Kind | [part(s)] | Kind | [part(s)] | [%] | [%] |
| Example 1 | Toner | t-Butyl | 7.0 | t-Butyl | 1.0 | Potassium | 1.0 | 50.0 | 80.0 |
| | 1 | peroxypivalate | | peroxyisobutyrate | | persulfate | | | |
| Example 2 | Toner | t-Butyl | 7.0 | t-Butyl | 1.0 | Potassium | 1.0 | 50.0 | 80.0 |
| | 2 | peroxypivalate | | peroxyisobutyrate | | persulfate | | | |
| Example 3 | Toner | t-Butyl | 7.0 | t-Butyl | 1.0 | Potassium | 1.0 | 50.0 | 80.0 |
| | 3 | peroxypivalate | | peroxyisobutyrate | | persulfate | | | |
| Example 4 | Toner | t-Butyl | 7.0 | t-Butyl | 1.0 | Potassium | 1.0 | 50.0 | 80.0 |
| | 4 | peroxypivalate | | peroxyisobutyrate | | persulfate | | | |
| Example 5 | Toner | t-Butyl | 7.0 | t-Butyl | 1.0 | Potassium | 1.0 | 50.0 | 80.0 |
| | 5 | peroxypivalate | | peroxyisobutyrate | | persulfate | | | |
| Example 6 | Toner | t-Butyl | 7.0 | t-Butyl | 1.0 | Potassium | 1.0 | 50.0 | 80.0 |
| | 6 | peroxypivalate | | peroxyisobutyrate | | persulfate | | | |
| Example 7 | Toner | t-Butyl | 7.0 | t-Butyl | 1.0 | Potassium | 0.1 | 50.0 | 80.0 |
| | 7 | peroxypivalate | | peroxyisobutyrate | | persulfate | | | |
| Example 8 | Toner | t-Butyl | 7.0 | t-Butyl | 1.0 | Potassium | 0.5 | 50.0 | 80.0 |
| | 8 | peroxypivalate | | peroxyisobutyrate | | persulfate | | | |
| Example 9 | Toner | t-Butyl | 7.0 | t-Butyl | 1.0 | Potassium | 1.0 | 50.0 | 75.0 |
| | 9 | peroxypivalate | | peroxyisobutyrate | | persulfate | | | |
| Example 10 | Toner | t-Butyl | 7.0 | t-Butyl | 1.0 | Potassium | 1.5 | 50.0 | 80.0 |
| | 10 | peroxypivalate | | peroxyisobutyrate | | persulfate | | | |
| Example 11 | Toner | t-Butyl | 7.0 | t-Butyl | 1.0 | Potassium | 2.0 | 50.0 | 80.0 |
| | 1 | peroxypivalate | | peroxyisobutyrate | | persulfate | | | |
| Example 12 | Toner | t-Butyl | 7.0 | t-Butyl | 1.0 | Ammonium | 1.0 | 50.0 | 80.0 |
| | 12 | peroxypivalate | | peroxyisobutyrate | | persulfate | | | |
| Example 13 | Toner | t-Butyl | 7.0 | t-Butyl | 1.0 | Potassium | 1.0 | 50.0 | 80.0 |
| | 13 | peroxypivalate | | peroxyisobutyrate | | persulfate | | | |
| Example 14 | Toner | t-Butyl | 7.0 | t-Butyl | 1.0 | Potassium | 1.0 | 50.0 | 80.0 |
| | 14 | peroxypivalate | | peroxyisobutyrate | | persulfate | | | |
| Example 15 | Toner | t-Butyl | 7.0 | t-Butyl | 1.0 | Potassium | 1.0 | 50.0 | 80.0 |
| | 15 | peroxypivalate | | peroxyisobutyrate | | persulfate | | | |
| Example 16 | Toner | t-Butyl | 7.0 | t-Butyl | 1.0 | Potassium | 1.0 | 32.0 | 55.0 |
| | 16 | peroxypivalate | | peroxyisobutyrate | | persulfate | | | |
| Example 17 | Toner | t-Butyl | 7.0 | t-Butyl | 1.0 | Potassium | 1.0 | 65.0 | 88.0 |
| | 17 | peroxypivalate | | peroxyisobutyrate | | persulfate | | | |
| Comparative | Toner | t-Butyl | 10.0 | — | — | — | — | — | — |
| Example 1 | 18 | peroxypivalate | | | | | | | |
| Comparative | Toner | t-Butyl | 7.0 | t-Butyl | 1.0 | — | — | — | — |
| Example 2 | 19 | peroxypivalate | | peroxyisobutyrate | | | | | |
| Comparative | Toner | t-Butyl | 7.0 | t-Butyl | 1.0 | — | — | — | — |
| Example 3 | 20 | peroxypivalate | | peroxyisobutyrate | | | | | |
| Comparative | Toner | Described in production example of toner particles 21 | | | | | | | |
| Example 4 | 21 | | | | | | | | |

TABLE 3

Unit (a)

| | | Number of carbon | Ratio |
|---|---|---|---|
| | Toner No. | atoms of alkyl group | [part(s)] |
| Example 1 | Toner 1 | 22 | 50.0 |
| Example 2 | Toner 2 | 22 | 45.0 |
| Example 3 | Toner 3 | 22 | 38.0 |
| Example 4 | Toner 4 | 22 | 42.0 |
| Example 5 | Toner 5 | 22 | 78.0 |
| Example 6 | Toner 6 | 22 | 82.0 |
| Example 7 | Toner 7 | 22 | 50.0 |
| Example 8 | Toner 8 | 22 | 50.0 |
| Example 9 | Toner 9 | 22 | 49.0 |
| Example 10 | Toner 10 | 22 | 50.0 |
| Example 11 | Toner 11 | 22 | 50.0 |
| Example 12 | Toner 12 | 22 | 50.0 |
| Example 13 | Toner 13 | 22 | 50.0 |
| Example 14 | Toner 14 | 18 | 50.0 |
| Example 15 | Toner 15 | 30 | 50.0 |
| Example 16 | Toner 16 | 22 | 50.0 |
| Example 17 | Toner 17 | 22 | 50.0 |
| Comparative | Toner 18 | — | — |
| Example 1 | | | |
| Comparative | Toner 19 | 22 | 50.0 |
| Example 2 | | | |
| Comparative | Toner 20 | 22 | 90.0 |
| Example 3 | | | |
| Comparative | Toner 21 | 18 | 49.0 |
| Example 4 | | | |

TABLE 4

| | | | Conductivity | Conductivity index | | Sulfo group |
|---|---|---|---|---|---|---|
| | | Polarization | κ (0.01 | κ/ω (0.01 | κ/ω (mini- | Intensity Ic1 |
| | Toner | charge | Hz) ×10⁻¹⁴ | Hz) ×10⁻¹³ | mum) ×10⁻¹³ | detected by |
| | No. | Δεr | [S/m] | [(S/m)(s/rad)] | [(S/m)(s/rad)] | TOF-SIMS |
| Example 1 | Toner 1 | 0.26 | 2.5 | 4.0 | 1.6 | 0.020 |
| Example 2 | Toner 2 | 0.32 | 3.5 | 5.5 | 1.5 | 0.015 |
| Example 3 | Toner 3 | 0.20 | 1.1 | 1.8 | 1.3 | 0.025 |
| Example 4 | Toner 4 | 0.24 | 2.1 | 3.4 | 1.8 | 0.015 |
| Example 5 | Toner 5 | 0.48 | 6.6 | 10.5 | 2.0 | 0.020 |
| Example 6 | Toner 6 | 0.50 | 7.1 | 11.3 | 2.1 | 0.030 |
| Example 7 | Toner 7 | 0.51 | 7.4 | 11.7 | 2.2 | 0.003 |
| Example 8 | Toner 8 | 0.48 | 6.9 | 11.0 | 1.9 | 0.005 |
| Example 9 | Toner 9 | 0.20 | 1.0 | 2.0 | 1.4 | 0.045 |
| Example 10 | Toner 10 | 0.25 | 2.1 | 3.4 | 1.3 | 0.050 |
| Example 11 | Toner 11 | 0.19 | 1.1 | 1.8 | 1.4 | 0.060 |
| Example 12 | Toner 12 | 0.46 | 6.1 | 9.7 | 1.7 | 0.010 |
| Example 13 | Toner 13 | 0.25 | 2.2 | 3.5 | 1.5 | 0.020 |
| Example 14 | Toner 14 | 0.21 | 1.2 | 1.9 | 1.8 | 0.025 |
| Example 15 | Toner 15 | 0.23 | 2.2 | 3.5 | 1.5 | 0.020 |
| Example 16 | Toner 16 | 0.48 | 6.2 | 10.0 | 2.0 | 0.006 |
| Example 17 | Toner 17 | 0.23 | 2.1 | 3.4 | 1.3 | 0.035 |
| Comparative | Toner 18 | 0.19 | 4.1 | 6.6 | 0.9 | 0.000 |
| Example 1 | | | | | | |
| Comparative | Toner 19 | 0.52 | 4.5 | 7.1 | 2.4 | 0.000 |
| Example 2 | | | | | | |
| Comparative | Toner 20 | 0.85 | 16.3 | 26.0 | 1.2 | 0.000 |
| Example 3 | | | | | | |
| Comparative | Toner 21 | 0.52 | 4.4 | 7.0 | 2.3 | 0.002 |
| Example 4 | | | | | | |

[Method of Evaluating Toner]

The performance evaluations of each of the toners 1 to 17 according to Examples 1 to 17 and the toners 18 to 21 according to Comparative Examples 1 to 4 were performed by the following procedures. The evaluation results of the respective toners are shown in Table 5. The values of the weight-average particle diameters (D4) of the respective toner particles are also shown in Table 5.

(Evaluation of Low-Temperature Fixability)

In the evaluation of low-temperature fixability, a laser beam printer: HP LaserJet Enterprise 600 M603 manufactured by Hewlett-Packard Company from which a fixing unit had been removed was prepared. In addition, the removed fixing unit was reconstructed so that its temperature was able to be freely set and its process speed became 400 mm/sec.

An unfixed image having a toner laid-on level per unit area of 0.5 mg/cm′ was produced under a normal-temperature and normal-humidity environment (at a temperature of 23.5° C. and a humidity of 60% RH) with the above-mentioned printer. Next, the unfixed image was passed through the above-mentioned fixing unit regulated to 130° C. “Prober Bond Paper” (105 g/m², manufactured by Fox River) was used as a recording medium. The resultant fixed image was reciprocally rubbed five times with lens-cleaning paper having applied thereto a load of 4.9 kPa (50 g/cm²), and the percentage (%) by which its image density reduced after the rubbing as compared to that before the rubbing was evaluated. The image density was measured with a spectral densitometer 500 Series (X-Rite, Inc.).
A: The percentage by which the image density reduces is less than 5.0%.
B: The percentage by which the image density reduces is 5.0% or more and less than 10.0%.
C: The percentage by which the image density reduces is 10.0% or more and less than 15.0%.
D: The percentage by which the image density reduces is 15.0% or more.

(Evaluation of Durable Developability; Development Stripe)

A reconstructed machine of a commercial laser beam printer LBP7600C manufactured by Canon Inc. was used as an evaluation machine. The printer was reconstructed in terms of the following points: its process speed and fixation temperature were set to 400 mm/sec and 130° C., respectively by changing the main body and software of the evaluation machine.

A toner stored in a process cartridge for a black toner mounted on the color laser printer was removed, and the inside was cleaned through air blowing. After that, each toner (40 g) was introduced into the process cartridge, and the process cartridge refilled with the toner was mounted on the color laser printer, followed by the following image evaluation. Specific image evaluation items are as described below.

A horizontal-line image having a print percentage of 0.5% was printed out on 10,000 sheets of letter-size Xerox 4200 Paper (manufactured by Xerox Corporation, 75 g/m²) under a high-temperature and high-humidity environment (at a temperature of 33° C. and a humidity of 85% RH) with the above-mentioned printer. After that, a halftone image (having a toner laid-on level of 0.2 mg/cm²) and a developing roller were evaluated for development stripes. Evaluation criteria were set as described below, and a result of C or more was judged to be satisfactory.

(Evaluation Criteria)
A: Two or less development stripes in a circumferential direction are observed on the developing roller. Alternatively, no vertical stripes in a sheet-discharging direction are observed on the image.
B: Three or more and five or less development stripes in the circumferential direction are observed on the developing roller. Alternatively, vertical stripes in the sheet-discharging direction are slightly observed on the image.
C: Six or more and twenty or less fine stripes in the circumferential direction are observed on the developing roller. Alternatively, five or less fine vertical stripes in the sheet-discharging direction are observed on the image.
D: Twenty-one or more stripes in the circumferential direction are observed on the developing roller. Alternatively, a stripe having a width of 0.5 mm or more is, or six or more fine stripes are, observed on the image.

TABLE 5

| | | Weight- | Low-temperature | | | | |
|---|---|---|---|---|---|---|---|
| | | average | fixability | | Durable Developability under high | | |
| | | particle | Percentage | | temperature and high humidity | | |
| | | diameter | by which | | Stripes on | | |
| | | of toner | image | | developing | Stripe on | |
| | | particles | density | Evaluation | roller | paper | Evaluation |
| | Toner No. | (μm) | reduces | result | (number) | image/width | result |
| Example 1 | Toner 1 | 6.4 | 2.5% | A | 1 stripe | — | A |
| Example 2 | Toner 2 | 6.3 | 3.2% | A | 2 stripes | — | A |
| Example 3 | Toner 3 | 6.3 | 12.1% | C | 0 stripe | — | A |
| Example 4 | Toner 4 | 6.3 | 5.1% | B | 1 stripe | — | A |
| Example 5 | Toner 5 | 6.3 | 4.2% | A | 5 stripes | — | B |
| Example 6 | Toner 6 | 6.3 | 4.9% | A | 6 stripes | — | C |
| Example 7 | Toner 7 | 6.4 | 5.2% | B | 18 stripes | — | C |
| Example 8 | Toner 8 | 6.3 | 5.0% | B | 5 stripes | — | B |
| Example 9 | Toner 9 | 6.3 | 10.2% | C | 0 stripes | — | A |
| Example 10 | Toner 10 | 6.4 | 4.2% | A | 1 stripe | — | A |
| Example 11 | Toner 11 | 6.3 | 10.2% | C | 0 stripes | — | A |
| Example 12 | Toner 12 | 6.3 | 4.8% | A | 3 stripes | — | B |
| Example 13 | Toner 13 | 6.2 | 3.0% | A | 2 stripes | — | A |
| Example 14 | Toner 14 | 6.3 | 5.0% | B | 1 stripe | — | A |
| Example 15 | Toner 15 | 6.3 | 4.5% | A | 1 stripe | — | A |
| Example 16 | Toner 16 | 6.3 | 7.2% | B | 5 stripes | — | B |
| Example 17 | Toner 17 | 6.4 | 8.1% | B | 2 stripes | — | A |
| Comparative | Toner 18 | 6.4 | 24.5% | D | 2 stripes | — | A |
| Example 1 | | | | | | | |
| Comparative | Toner 19 | 6.3 | 1.8% | A | 21 stripes | — | D |
| Example 2 | | | | | | | |
| Comparative | Toner 20 | 6.2 | 1.2% | A | — | A width of | D |
| Example 3 | | | | | | 0.8 mm | |
| Comparative | Toner 21 | 5.9 | 15.2% | D | 20 stripes | — | C |
| Example 4 | | | | | | | |

According to the present disclosure, the toner having both of excellent low-temperature fixability and such high durable developability as to be free from causing any development stripe can be provided.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-069392, filed Apr. 20, 2022, which is hereby incorporated by reference herein in its entirety.

What is claimed is:

1. A toner comprising:
a toner particle containing a crystalline resin as a binder resin,
wherein when a relative permittivity obtained at a time of impedance measurement of the toner under an environment at a temperature of 25° C. and a relative humidity of 50% is represented by εr, a difference Δεr between a relative permittivity εr(0.01 Hz) at a frequency of 0.01 Hz and a relative permittivity εr(383 kHz) at a frequency of 383 kHz satisfies a relationship of 0.21≤{εr(0.01 Hz)-εr(383 kHz)}≤0.48.

2. The toner according to claim 1, wherein the difference Δεr between the relative permittivity εr(0.01 Hz) and the relative permittivity εr(383 kHz) satisfies a relationship of 0.25≤{εr(0.01 Hz)-εr(383 kHz)}≤0.45.

3. The toner according to claim 1, wherein when a conductivity obtained at the time of the impedance measurement of the toner under the environment at a temperature of 25° C. and a relative humidity of 50% is represented by κ, the toner has a conductivity κ [S/m] of 1.2×10⁻¹⁴ or more and 7.1×10⁻¹⁴ or less at a frequency of 0.01 Hz.

4. The toner according to claim 1, wherein when a conductivity index obtained at the time of the impedance measurement of the toner under the environment at a temperature of 25° C. and a relative humidity of 50% is represented by κ/ω, the toner has a conductivity index κ/ω [(S/m)(s/rad)] of 1.9×10⁻¹³ or more and 11.4×10⁻¹³ or less at a frequency of 0.01 Hz.

5. The toner according to claim 1, wherein when a conductivity index obtained at the time of the impedance measurement of the toner under the environment at a temperature of 25° C. and a relative humidity of 50% is represented by κ/ω, the conductivity index κ/ω [(S/m)(s/rad)] of the toner has a minimum of 1.3×10⁻¹³ or more and 2.0×10⁻¹³ or less at a sweep frequency of 0.01 Hz or more and 383 kHz or less.

6. The toner according to claim 1, wherein the binder resin contains a unit (a) represented by following formula (2): 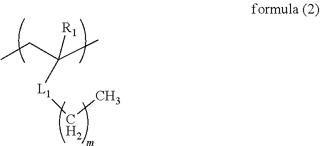
in the formula (2), R₁ represents a hydrogen atom or a methyl group, L₁ represents a single bond or a divalent linking group, and m represents an integer of 15 or more and 35 or less.

7. The toner according to claim 6, wherein a ratio of the unit (a) represented by the formula (2) in the binder resin is 40.0% by mass or more and 80.0% by mass or less.

8. The toner according to claim 1, wherein when in measurement of a surface of the toner particle by time-of-flight secondary ion mass spectrometry TOF-SIMS, an ion count derived from a sulfo group with respect to a total ion count at a mass-to-charge ratio of from 0.5 to 1,850 is represented by Ic1, the Ic1 is 0.005 or more and 0.05 or less.
